(19) United States
(12) Patent Application Publication
(10) Pub. No.: US 2026/0034623 A1
(43) Pub. Date: Feb. 5, 2026

(54) MODULAR SELF-CONFIGURING INDUSTRIAL TABLE

(71) Applicant: EMI INTEGRATED SYSTEMS LTD., Ad Halom (IL)

(72) Inventor: Joshua Ulmer, Kohav Michael (IL)

(21) Appl. No.: 19/302,044

(22) Filed: Aug. 17, 2025

Related U.S. Application Data
(62) Division of application No. 17/717,508, filed on Apr. 11, 2022.

(51) Int. Cl. B23Q 1/74; A47B 1/02; B23Q 1/03

(52) U.S. Cl. CPC B23Q 1/74; A47B 1/02; B23Q 1/032; A47B 2200/0001

(57) ABSTRACT

A modular tabletop apparatus, typically used for workpiece storage and handling during robotic manipulation and feeding to a machine, is disclosed. Modules of the apparatus comprise detection interfaces disposed at locations corresponding to module edge locations and arranged in a periodic grid. Alignment of facing detection interfaces along common edges of pairs of adjacent modules permits module controllers to detect neighboring modules, and a main controller to compute the overall size and shape of the tabletop formed by the modules. Connecting arrangements are also disclosed. The connecting arrangements may be placed at the same grid locations as the detection interfaces, advantageously permitting alignment of detection interfaces for any interconnection configuration of modules. Modules may comprise plates with a grid of positioning indentations. The period of the positioning grid can be an integer multiple or integer fraction of that of the interface/connection grid.

### RELATED APPLICATION

This application is a continuation application of U.S. application Ser. No. 17/717,508, filed Apr. 11, 2022, the entire contents of which are hereby incorporated by reference.

### FIELD OF THE INVENTION

The invention is in the field of industrial workpiece operations such as handling, processing, and assembly; and in particular to a modular tabletop apparatus for workpiece storage, processing and handling during robotic manipulation.

### BACKGROUND TO THE INVENTION

Industrial tabletops are disclosed in the prior art:

US2014248113A discloses a modular fixture plate system comprising: at least one interlocking fixture plate comprising at least one of a male end and a female end, wherein the male end comprises at least one male projection and the female end comprises at least one female recess; and a docking plate comprising at least one of at least one male projection and at least one female recess; wherein at least one male projection or female recess of the at least one interlocking fixture plate is interlocked with a mating one of the at least one male projection or the at least one female recess of the docking plate.

EP0476188A1 discloses a holding device which can be used for the general processing of workpieces of different size which are to be fixed or mounted on a common foundation (9) by means of holding members during the processing. A single rectangular and thus one-piece planar and flexurally rigid holding plate is used in a simple manner for clamping or mounting a workpiece thereon in such a way that processing only takes place after the common foundation for holding a workpiece, for adaptation to every workpiece of the most varied dimensions, is assembled like a modular system, to make a holding device of the type described above, from a plurality of preferably polygonal holding panels which, in advance of the planned clamping, depending on the required size, are mutually coupled to one another in a flexurally rigid manner in their edge areas in such a way that the holding panels thus coupled form as a body a one-piece, integral workpiece-holding surface which can easily be extended or reduced as desired, whereupon workpieces of any size can now be clamped or mounted in position as usual.

The present invention expands the features and utility of industrial tabletops, as disclosed herein.

### SUMMARY

An aspect of the present invention relates to a modular tabletop apparatus. The apparatus is typically used for workpiece storage and handling, during robotic manipulation and feeding to a machine, and/or used in automated or semi-automated manufacturing and assembly line processes of products. The tabletop is assembled as a tessellation of modules. The modules can have positioning arrangements, disposed on the surface of modules, for accurate positioning of workpiece-handling elements; and/or can have connection arrangements, disposed around the sides of modules, for physical interconnection of modules. For each module, locations of positioning and/or connection arrangements can be disposed periodically, at a uniform period(s) for all modules in a tabletop. Furthermore, extents (e.g., for rectangular modules, two extents—widths and lengths) of adjacent modules in the tessellation can be some integer multiple of both periods, enabling the positioning and/or connection arrangements to retain their periodicities over multiple modules, which can include up to the entire tabletop.

Another aspect of the invention relates to a tabletop apparatus in which modules possess detection interfaces disposed around their sides, and to a method for self-configuration of the tabletop; that is, a main controller of the tabletop apparatus can compute the size and shape of the tabletop. The detection interfaces can be periodically disposed (at any vertical level) around the sides of the modules at a uniform period for all modules. A pair of facing detection interfaces of two adjacent modules comprise at least one sensor, capable of reporting an identifier of the facing detection interface. The identifier reveals the size of the adjacent module and the position of the facing detection interface with respect to a reference origin of the adjacent module. The main controller collects at least one such adjacent-module identifier from each module, and is thereby able to define relative positions of adjacent modules and, consequently, a plurality of modules including up to all modules in the tabletop. The main controller is thereby enabled to compute the overall size and shape of the tabletop.

(Definitions of terms used is found in the Definitions section of the Detailed Description.)

It is therefore within the scope of a first aspect of the invention to provide a modular, self-configuring tabletop apparatus comprising
a. one or more modules 104; the modules 104 configured to form a tessellation by a side-by-side placement of the modules 104; each the module comprising one or more detection interfaces disposed along the module extents or edges; the detection interfaces are configured to occupy locations periodically spaced in one or more dimensions of the tessellation by an interface-location period of each the one or more dimensions, such that one or more pairs of the detection interfaces on the adjacent modules face each other; each the pair of facing detection interfaces comprising at least one sensor; an output of each the sensor indicates whether or not the detection interface is facing a detection interface 107′ of the adjacent module; a tessellation extent of each the module along each the edge that comprises the periodically spaced interface locations is an integer multiple of the interface-location period of the dimension;
b. a main controller 120M configured to receive from each module the locations of one or more sensors facing a detection interface of the adjacent module and the tessellation extents of the module, or codes associated therewith;
wherein the main controller 120M is further configured to compute tessellation extents of the tabletop in the one or more dimensions as a function of the interface-location period and the sensor outputs.

It is further within the scope of the first aspect of the invention to provide the above apparatus wherein one or more of the interface locations is unpopulated by a detection interface.

It is further within the scope of the first aspect of the invention to provide the above apparatus wherein one or more of the detection interfaces are disposed on a structural support supporting a module.

It is further within the scope of the first aspect of the invention to provide the above apparatus, wherein the module shapes are any combination of rectangles, triangles, quadrilaterals, hexagons, and octagons.

It is further within the scope of the first aspect of the invention to provide the above apparatus, wherein the modules are rectangular.

It is further within the scope of the first aspect of the invention to provide the above apparatus, wherein the two outermost interface locations on edges of each the module are spaced from nearest endpoints of each of the edge by up to one-half of the interface-location period (Pᵢ).

It is further within the scope of the first aspect of the invention to provide the above apparatus, wherein the two outermost interface locations on edges of each module are spaced from nearest endpoints of each of the edge by up to one the interface-location period.

It is further within the scope of the first aspect of the invention to provide the above apparatus, wherein the interface locations are periodic in an x-dimension at an interface-location period Pᵢₓ and in a y-dimension at a interface-location period P_{iy}, the main module further configured to compute a shape of the tabletop, optionally including the possibility to compute the positioning grid and layout of an area occupied by modules up to the entire module tessellation area, including positioning calculation relative to another coordinate system such as such as a robot coordinate system axis that is connected or positioned in connection with the table top modules in the tessellation.

It is further within the scope of the first aspect of the invention to provide the above apparatus, wherein each the module further comprises one or more connection arrangements configured for physically attaching the adjacent modules; the connection arrangements disposed along edges of the modules and occupy locations periodically spaced in the one or more dimensions of the tabletop by a connection-location period of each the one or more dimensions, such that pairs of the connection arrangements of the adjacent modules meet along the adjacent edges of the adjacent modules; a tessellation extent of each the module along each the edge that comprises the periodically spaced connection locations (P_{c}) is an integer multiple of the connection-location period of the dimension.

It is further within the scope of the first aspect of the invention to provide the above apparatus, wherein the connection arrangements 112 serve as accurate physical alignment mechanism between modules.

It is further within the scope of the first aspect of the invention to provide the above apparatus, wherein the two outermost connection locations on edges of each the module are spaced from nearest endpoints of each of the edge by up to one-half of the connection period (P_{c}).

It is further within the scope of the first aspect of the invention to provide the above apparatus, wherein the two outermost connection locations on edges of each the module are spaced from nearest endpoints of each of the edge by up to one the connection period (P_{c}).

It is further within the scope of the first aspect of the invention to provide the above apparatus, wherein the connection locations are periodic in the x-dimension at a connection period P_{cx} and in the y-dimension at a connection period P_{cy}.

It is further within the scope of the first aspect of the invention to provide the above apparatus, wherein the interface period in the x-dimension and the interface period in the y-dimension are equal (Pᵢₓ=P_{iy}).

It is further within the scope of the first aspect of the invention to provide the above apparatus, wherein the connection period in the x-dimension and the connection period in the y-dimension are equal (P_{cx}=P_{cy}).

It is further within the scope of the first aspect of the invention to provide the above apparatus, wherein the interface period in the x-dimension and the connection period in the x-dimension are equal (Pᵢₓ=P_{cx}=P_{icx}=P_{icx}); and the interface period in the y-dimension and the connection period in the y-dimension are equal (P_{iy}=P_{cy}=P_{icy}=P_{icy}).

It is further within the scope of the first aspect of the invention to provide the above apparatus, wherein the interface-connection x and y periods are equal (P_{icx}=P_{icy}=P_{ic}).

It is further within the scope of the first aspect of the invention to provide the above apparatus, wherein the modules comprise one or more plates, each the plate comprising positioning arrangements 110 thereon, the positioning arrangements disposed on a surface of the tabletop and/or the vertically position modules of the table top (FIG. 10H) at positioning locations periodically spaced in at least one dimension of the surface at a positioning period (Pₚ) of each of the at least one dimension; tessellation extents of each the module in each the at least one dimension is an integer multiple of the positioning period (Pₚ).

It is further within the scope of the first aspect of the invention to provide the above apparatus, wherein two outermost columns of positioning locations of the positioning arrangements are spaced from nearest edges of the positioning array by up to one-half of the positioning period (Pₚ).

It is further within the scope of the first aspect of the invention to provide the above apparatus, wherein two outermost columns of positioning arrangements of the positioning locations are spaced from nearest edges of the module by up to one positioning period (Pₚ).

It is further within the scope of the first aspect of the invention to provide the above apparatus, wherein the positioning locations have a positioning period along the x-dimension at a positioning period Pₚₓ and along the y-dimension at a positioning period P_{py}.

It is further within the scope of the first aspect of the invention to provide the above apparatus, wherein the interface-connection period in the x-dimension (P_{icx}) is an integer multiple of the positioning period in the x-dimension (P_{icx}=mPₚₓ); and the interface-connection period in the y-dimension is an integer multiple of the positioning period in the y-dimension (P_{icy}=nP_{iy}).

It is further within the scope of the first aspect of the invention to provide the above apparatus, wherein the x and y interface-connection periods are equal to the x and y positioning periods (P_{icx}=P_{icy}=mPₚₓ=nP_{py}; m=n).

It is further within the scope of the first aspect of the invention to provide the above apparatus, wherein the modules comprise one or more plates, each the plate comprising positioning arrangements 110 thereon, each the plate 105 comprising one or more positioning arrangements 110 thereon, the positioning arrangements disposed on a surface of the tabletop at positioning locations periodically spaced in at least one dimension of the surface at a positioning period of each of the at least one dimension; tessellation extents of each the module in each the at least one dimension is an integer multiple of the positioning period.

It is further within the scope of the first aspect of the invention to provide the above apparatus, wherein two outermost columns of positioning locations of the positioning arrangements are spaced from nearest edges of the module by up to one-half of the positioning period.

It is further within the scope of the first aspect of the invention to provide the above apparatus, wherein two outermost columns of positioning arrangements of the positioning locations are spaced from nearest edges of the module by up to one the positioning period.

It is further within the scope of the first aspect of the invention to provide the above apparatus, wherein the positioning locations have a positioning period along the x-dimension at a positioning period Pₚₓ and along the y-dimension at a positioning period P_{py}.

It is further within the scope of the first aspect of the invention to provide the above apparatus, wherein the interface period in the x-dimension is an integer multiple of the positioning period in the x-dimension (Pᵢₓ=mPₚₓ); and the interface period in the y-dimension is an integer multiple of the positioning period in the y-dimension (P_{iy}=nP_{py}).

It is further within the scope of the first aspect of the invention to provide the above apparatus, wherein the x and y interface periods are equal and the x and y positioning periods are equal (Pᵢₓ=P_{iy}=Pᵢ=nPₚₓ=nP_{py}=nPp; m=n)

It is further within the scope of the first aspect of the invention to provide the above apparatus, wherein each the module further comprises one or more connection arrangements 112 configured for connecting the adjacent modules; the connection arrangements occupy locations periodically spaced in the one or more dimensions of the tabletop by a connection period (P_{c}) of each the one or more dimensions, such that pairs of the connections arrangements of the adjacent modules meet along the adjacent edges of the adjacent modules; a tessellation extent of each the module along each the edge that comprises the periodically spaced connection locations is an integer multiple of the connection period (P_{c}) of the dimension.

It is further within the scope of the first aspect of the invention to provide the above apparatus, wherein the two outermost connection locations on edges of each the module are spaced from nearest endpoints of each of the edge by up to one-half of the interface period.

It is further within the scope of the first aspect of the invention to provide the above apparatus, wherein the two outermost connection locations on edges of each the module are spaced from nearest endpoints of each of the edge by up to one the connection period.

It is further within the scope of the first aspect of the invention to provide the above apparatus, wherein the connection locations are periodic in the x-dimension at a connection period P_{cx} and in the y-dimension at a connection period P_{cy}.

It is further within the scope of the first aspect of the invention to provide the above apparatus, wherein the interface period in the x-dimension and the connection period in the x-dimension are equal (Pᵢₓ=P_{cx}=P_{icx}=P_{icx}); and the interface period in the y-dimension and the connection period in the y-dimension are equal (P_{iy}=P_{cy}=P_{icy}=P_{icy}).

It is further within the scope of the first aspect of the invention to provide the above apparatus, wherein the interface-connection x and y periods are equal (P_{icx}=P_{icy}=P_{ic}).

It is further within the scope of the first aspect of the invention to provide the above apparatus, wherein the detection interfaces comprise transceivers, the transceivers of each the facing detection interfaces are configured to communicate, and each the module further comprises a controller in communicative connection with the transceivers of the facing detection interface and with the main controller. Optionally, one of the module controllers serves as the main controller.

It is further within the scope of the first aspect of the invention to provide the above apparatus, wherein the transceiver comprises an optical emitter and optical detector.

It is further within the scope of the first aspect of the invention to provide the above apparatus, wherein the transceiver comprises an RF emitter and an RF receiver.

It is further within the scope of the first aspect of the invention to provide the above apparatus, wherein the main controllers and module controllers are connected through a network dedicated to the apparatus and the module controller of each the module is further configured to report one or more of the facing transceivers of the module and the tessellation extents of the module, or codes associated therewith over, the network.

It is further within the scope of the first aspect of the invention to provide a method for self-configuration of a tabletop apparatus, comprising steps of
a. obtaining the previous apparatus;
b. obtaining, by the main controller, a data sequence associated with an access code to a network dedicated to said apparatus;
c. propagating the data sequence to the module controllers over the transceivers;
d. optionally, computing, by each module controller, said access code as function of at least the data sequence.
e. gaining access to the dedicated network, by each the module controller with its access code;
f. transmitting, by each module controller (first module controller) over each of the first module's transceivers, an exploratory data packet comprising an identifier of the first module controller, a module type of the first module, and an interface identifier of the exploratory transceiver;
g. receiving the exploratory packet by a controller of the second module, through a discovered transceiver of the second module;
h. adding, by the second module controller, the exploratory packet data and the identifier of the discovered transceiver of the second module to a connectivity table stored in the second module;
i. transmitting the connectivity tables to the main controller, over the network, by each discovered module controller;
j. constructing, by the main controller from the connectivity tables, a tessellation table comprising orientations of the modules, absolute coordinates of the facing transceivers, and extents of the tabletop, as a function of said connectivity tables;
k. mapping a tessellation of the modules, as a function of the tessellation tables.

It is further within the scope of the first aspect of the invention to provide the above method, further comprising steps of
a. transmitting, by the second module controller over the discovered interface, a discovery packet of data comprising an identifier of the second module controller, a module type of the second module, and an identifier of the discovered interface;
b. receiving the discovery packet by the first controller, over the through the exploratory transceiver from the discovered transceiver; and
c. adding, by the first module, the discovery packet data and the identifier of the exploratory transceiver of the first module to a connectivity mirror table stored in the first module.

It is further within the scope of the first aspect of the invention to provide the above method, further comprising a step of transforming coordinate systems when constructing the tessellation table.

It is further within the scope of the first aspect of the invention to provide the above method, wherein the coordinate systems are any combination of rectangular, hexagonal, and octagonal.

It is further within the scope of the first aspect of the invention to provide the above apparatus, wherein a means of communication within the network is over the transceivers.

It is further within the scope of the first aspect of the invention to provide the above apparatus, wherein
c. the main controller is further configured to send one or more access codes to each the module controller over the transceivers; and
d. the module controller sends the access code to the main controller over the network, thereby gaining access to the network.

It is further within the scope of the first aspect of the invention to provide the above apparatus, wherein the network is over cables, fiber, or wireless.

It is further within the scope of the first aspect of the invention to provide the above apparatus, wherein the network is wireless.

It is further within the scope of the first aspect of the invention to provide the above apparatus, wherein the main controller is configured to establish wireless connection with modules returning the access code over the wireless network and skip modules failing to return the access code over the wireless network.

It is within the scope of a second aspect of the invention to provide a tabletop apparatus comprising one or more modules each comprising one or more connection arrangements, wherein a surface of the module comprises one or more recesses, the recess reaching an edge of the module, wherein the recess and a facing recess of an adjacent module form an interlocking shape; the facing connection recesses are thereby configured to receive a connection insert of the interlocking shape.

It is further within the scope of the second aspect of the invention to provide the above apparatus, wherein a floor of the recess comprises a bore or a threaded hole configured for fastening the connection insert to the plate.

It is further within the scope of the second aspect of the invention to provide the above apparatus, wherein the interlocking shape possesses bilateral or rotational symmetry in at least one axis.

It is further within the scope of the second aspect of the invention to provide the above apparatus, wherein the interlocking shape is a dogbone, a barbell, an X, inverted Y's, an arrow, triangles, trapezoids, or any combination thereof.

It is further within the scope of the second aspect of the invention to provide the above apparatus, wherein one or more of the modules are oriented vertically and the connection inserts comprise a connection insert for connecting a vertically oriented module between two horizontally oriented modules and/or a connection insert for connecting two vertically oriented modules meeting at an angle, typically a right angle.

It is further within the scope of the second aspect of the invention to provide the above apparatus, wherein one or more of the modules are positioned horizontally or in an angle to and above the vertically oriented module and the connection inserts comprise a connection insert for connecting a vertically oriented module to a 2^{nd} horizontally oriented module on top of the vertically oriented module and/or a connection insert for connecting a number of vertically and stacked horizontally oriented modules meeting at an angle.

It is within the scope of a third aspect of the invention to provide a modular tabletop apparatus comprising one or more modules comprising one or more connection arrangements, the modules; the modules configured to form a tessellation by adjacent placement of the modules along edges of the modules; the connection arrangements are configured to occupy locations periodically spaced in one or more dimensions of the tessellation by a connection period (P_{c}) of each the one or more dimensions, such that one or more pairs of the connection arrangements on the adjacent modules meet along the edges of the adjacent modules; a tessellation extent of each the module along each the edge that comprises the periodically spaced connection locations is an integer multiple of the connection period of the dimension.

It is further within the scope of the third aspect of the invention to provide the above apparatus, wherein the connection arrangements comprise one or more recesses, the recess reaching an edge of the module, wherein the recess and a facing recess of an adjacent module form an interlocking shape; the facing connection recesses are thereby configured to receive a connection insert of the interlocking shape.

It is further within the scope of the third aspect of the invention to provide the above apparatus, wherein one or more of the modules are oriented vertically and the connection inserts comprise a connection insert for connecting a vertically oriented module between one or more horizontally oriented modules and/or a connection insert for connecting two vertically oriented modules meeting at an angle.

It is further within the scope of the third aspect of the invention to provide the above apparatus, wherein one or more of the modules are positioned horizontally or at an angle to and above vertically oriented module and the connection inserts comprise a connection insert for connecting a vertically oriented module to a 2^{nd} horizontally oriented module on top of the vertically oriented module and/or a connection insert for connecting a number of vertically and stacked horizontally oriented modules meeting at an angle.

It is further within the scope of the third aspect of the invention to provide the above apparatus, wherein one or more of the connection locations is unpopulated by a connection arrangement.

It is further within the scope of the third aspect of the invention to provide the above apparatus, wherein one or more of the connection arrangements are disposed on a structural support supporting the module, connection of the adjacent modules thereby secured at the structural supports of the adjacent modules.

It is further within the scope of the third aspect of the invention to provide the above apparatus, wherein the module shapes are any combination of triangles, quadrilaterals, hexagons 160, and octagons 165.

It is further within the scope of the third aspect of the invention to provide the above apparatus, wherein the module shapes are rectangles.

It is further within the scope of the third aspect of the invention to provide the above apparatus, wherein the two outermost connection locations on edges of each the module are spaced from nearest endpoints of each of the edge by up to one-half of the connection period.

It is further within the scope of the third aspect of the invention to provide the above apparatus, wherein the two outermost connection locations on edges of each the module are spaced from nearest endpoints of each of the edge by up to one the connection period.

It is further within the scope of the third aspect of the invention to provide the above apparatus, wherein the connection locations are periodic in the x-dimension at a connection period P_{cx} and in the y-dimension at a connection period P_{cy}.

It is further within the scope of the third aspect of the invention to provide the above apparatus, wherein
a. each the module further comprises one or more detection interfaces; the detection interfaces occupy locations periodically spaced in one or more dimensions of the tabletop by an interface period (Pᵢ) of each the one or more dimensions, such that one or more pairs of the detection interfaces of the adjacent modules meet along the adjacent edges of the adjacent modules, the edges that comprise periodically spaced interface locations are oriented in one or more dimensions of the tabletop; each the pair of facing detection interfaces comprising at least one sensor; an output of each the sensor indicates whether or not the detection interface is facing a detection interface 107′ of an adjacent module; a tessellation extent of each the module along each the edge that comprises periodically spaced interface locations is an integer multiple of the interface period of the dimension;
b. the apparatus further comprises a main controller 120M configured to receive from each module the locations of one or more sensors facing a detection interface of an adjacent module and the tessellation extents of the module, or codes associated therewith;
   wherein the main controller 120M is further configured to compute tessellation extents of the tabletop in the one or more dimensions as a function of the interface period and the sensor outputs.

It is further within the scope of the third aspect of the invention to provide the above apparatus, wherein two the outermost interface locations on edges of each the module are spaced from nearest endpoints of each of the edge by up to one-half of the interface period.

It is further within the scope of the third aspect of the invention to provide the above apparatus, wherein the two outermost interface locations on edges of each the module are spaced from nearest endpoints of each of the edge by up to one the interface period.

It is further within the scope of the third aspect of the invention to provide the above apparatus, wherein the interface locations are periodic in an x-dimension at an interface period Pᵢₓ and in a y-dimension at an interface period P_{iy}, the main module further configured to compute a shape of the tabletop.

It is further within the scope of the third aspect of the invention to provide the above apparatus, wherein the interface period in the x-dimension and the connection period in the x-dimension are equal (Pᵢₓ=P_{cx}=P_{icx}=P_{icx}); and the interface period in the y-dimension and the connection period in the y-dimension are equal (P_{iy}=P_{cy}=P_{icy}=P_{icy}).

It is further within the scope of the third aspect of the invention to provide the above apparatus, wherein the interface-connection x and y periods are equal (P_{icx}=P_{icy}=P_{ic}).

It is further within the scope of the third aspect of the invention to provide the above apparatus, wherein the modules comprise one or more plates, each the plate 105 comprising one or more positioning arrangements 110 thereon, the positioning arrangements disposed on a surface of the tabletop at positioning locations periodically spaced in at least one dimension of the surface at a positioning period of each of the at least one dimension; tessellation extents of each the module in each the at least one dimension is an integer multiple of the positioning period (Pₚ).

It is further within the scope of the third aspect of the invention to provide the above apparatus, wherein two outermost columns of positioning locations of the positioning arrangements are spaced from nearest edges of the module by up to one-half of the positioning period (Pₚ).

It is further within the scope of the third aspect of the invention to provide the above apparatus, wherein two outermost columns of positioning arrangements of the positioning locations are spaced from nearest edges of the module by up to one positioning period (Pₚ).

It is further within the scope of the third aspect of the invention to provide the above apparatus, wherein the positioning locations have a positioning period along the x-dimension at a positioning period Pₚₓ and along the y-dimension at a positioning period P_{py}.

It is further within the scope of the third aspect of the invention to provide the above apparatus, wherein the interface-connection period in the x-dimension is a multiple of the positioning period in the x-direction (P_{icx}=mPₚₓ); and the interface-connection period in the y-dimension is a multiple of the positioning period in the y-direction (P_{icy}=nP_{iy}), wherein m and n are integers.

It is further within the scope of the third aspect of the invention to provide the above apparatus, wherein the x and y connecting-interface periods are equal and the x and y positioning periods are equal (Pᵢₓ=P_{iy}=Pᵢ and Pₚₓ=P_{py})

It is further within the scope of the third aspect of the invention to provide the above apparatus, wherein the modules comprise one or more plates, each plate comprising positioning arrangements 110 thereon, one or more the positioning arrangements disposed at positioning locations along each of one or more rows on the plate, each row oriented along at least one dimension of the rectangle, the positioning locations are periodically spaced along the rows in a dimension at a positioning period of the dimension; tessellation extents of each the module in each the at least one dimension is an integer multiple of the positioning period.

It is further within the scope of the third aspect of the invention to provide the above apparatus, wherein two outermost columns of positioning locations of the positioning arrangements are spaced from nearest edges of the module by up to one-half of the positioning period.

It is further within the scope of the third aspect of the invention to provide the above apparatus, wherein two outermost columns of positioning arrangements of the positioning locations are spaced from nearest edges of the module by up to one the positioning period.

It is further within the scope of the third aspect of the invention to provide the above apparatus, wherein the positioning locations have a positioning period along the x-dimension at a positioning period Pₚₓ and along the y-dimension at a positioning period P_{py}.

It is further within the scope of the third aspect of the invention to provide the above apparatus, wherein the connection period in the x-dimension is an integer multiple of the positioning period in the x-dimension (P_{cx}=mPₚₓ); and the connection period in the y-dimension is an integer multiple of the positioning period in the y-dimension (P_{cy}=nP_{iy}).

It is further within the scope of the third aspect of the invention to provide the above apparatus, wherein the x and y interface-connection periods are equal to the x and y positioning periods (P_{icx}=P_{icy}=mPₚₓ=nP_{py}; m=n).

It is further within the scope of the third aspect of the invention to provide the above apparatus, wherein
a. each the module further comprises one or more detection interfaces; the detection interfaces occupy locations periodically spaced in one or more dimensions of the tabletop by an interface period of each the one or more dimensions, such that one or more pairs of the detection interfaces of the adjacent modules meet along the adjacent edges of the adjacent modules, the edges that comprise periodically spaced interface locations are oriented in one or more dimensions of the tabletop; each the pair of facing detection interfaces comprising at least one sensor; an output of each the sensor indicates whether or not the detection interface is facing a detection interface 107′ of an adjacent module; a tessellation extent of each the module along each the edge that comprises periodically spaced interface locations is an integer multiple of the interface period of the dimension;
b. the apparatus further comprises a main controller 120M configured to receive from each module the locations of one or more sensors facing a detection interface of an adjacent module and the tessellation extents of the module, or codes associated therewith;
   wherein the main controller 120M is further configured to compute tessellation extents of the tabletop in the one or more dimensions as a function of the interface period and the sensor outputs.

It is further within the scope of the third aspect of the invention to provide the above apparatus, wherein the two outermost interface locations on edges of each the module are spaced from nearest endpoints of each of the edge by up to one-half of the interface period.

It is further within the scope of the third aspect of the invention to provide the above apparatus, wherein the two outermost interface locations on edges of each the module are spaced from nearest endpoints of each of the edge by up to one the interface period.

It is further within the scope of the third aspect of the invention to provide the above apparatus, wherein the interface locations are periodic in an x-dimension at an interface period Pᵢₓ and in a y-dimension at an interface period P_{iy}, the main module further configured to compute a shape of the tabletop.

It is further within the scope of the third aspect of the invention to provide the above apparatus, wherein the interface period in the x-dimension and the connection period in the x-dimension are equal (Pᵢₓ=P_{cx}=P_{icx}); and the interface period in the y-dimension and the connection period in the y-dimension are equal (P_{iy}=P_{cy}=P_{icy}).

It is further within the scope of the third aspect of the invention to provide the above apparatus, wherein the interface-connection x and y periods are equal (P_{icx}=P_{icy}=P_{ic}).

It is within the scope of a fourth aspect of the invention to provide a modular tabletop apparatus comprising one or more modules 104, the modules 104 comprising one or more plates 105; the modules 104 configured to form a tessellation by adjacent placement of the modules 104 along edges of the modules 104; each the plate 105 comprising one or more positioning arrangements 110 disposed thereon, the positioning arrangements configured to occupy locations periodically spaced in one or more dimensions of the tessellation by a positioning period of each the one or more dimensions; tessellation extents of each the module in each the at least one dimension is an integer multiple of the positioning period; wherein the positioning arrangement comprises a recess in the plate, configured to receive a placement insert in a shape of the recess.

It is further within the scope of the fourth aspect of the invention to provide the above apparatus, wherein the shapes of the recesses comprise any combination of circles and shapes having n-fold rotational symmetry of order of any integer n greater than 1.

It is further within the scope of the fourth aspect of the invention to provide the above apparatus, wherein the shapes of the recesses lack rotational symmetry of any order, thereby the positioning elements are insertable into the recess in only one orientation.

It is further within the scope of the fourth aspect of the invention to provide the above apparatus, wherein the shapes of the recess is any combination of a “D,” two non-congruent circles, and an imbalanced ellipse.

It is further within the scope of the fourth aspect of the invention to provide the above apparatus, wherein one or more of the positioning locations is unpopulated by a positioning arrangement.

It is further within the scope of the fourth aspect of the invention to provide the above apparatus, wherein the plates are any combination of triangular, rectangular, hexagonal, or octagonal.

It is further within the scope of the fourth aspect of the invention to provide the above apparatus, wherein the modules are rectangular.

It is further within the scope of the fourth aspect of the invention to provide the above apparatus, wherein two outermost columns of positioning arrangements are spaced from nearest edges of the module by up to one-half of the positioning period.

The apparatus of claim 86, wherein two outermost columns of positioning arrangements are spaced from nearest edges of the module by up to one the positioning period.

It is further within the scope of the fourth aspect of the invention to provide the above apparatus, wherein a positioning grid has a positioning period along x-dimension at a positioning period Pₚₓ and along y-dimension at a positioning period P_{py}.

It is further within the scope of the fourth aspect of the invention to provide the above apparatus, wherein each the module further comprises one or more connection arrangements 115 configured for attaching the adjacent modules; the connection arrangements are disposed along one or more edges of each the module, the edges oriented along at least one dimension of the rectangle, the connection arrangements are periodically spaced along the edges in a dimension at an connection period of the dimension; tessellation extents of each the module in each the at least one dimension is an integer multiple of the connection period.

It is further within the scope of the fourth aspect of the invention to provide the above apparatus, wherein the connection arrangements comprise one or more recesses, the recess reaching an edge of the module, wherein the recess and a facing recess of an adjacent module form an interlocking shape; the facing connection recesses are thereby configured to receive a connection insert of the interlocking shape.

It is further within the scope of the fourth aspect of the invention to provide the above apparatus, wherein one or more of the modules are oriented vertically and the connection inserts comprise a connection insert for connecting a vertically oriented module between two horizontally oriented modules and/or a connection insert for connecting two vertically oriented modules meeting at an angle; further wherein the positioning arrangements are on either one or both sides of the plates.

It is further within the scope of the fourth aspect of the invention to provide the above apparatus, wherein the two outermost connection locations on edges of each the module are spaced from nearest endpoints of each of the edge by up to one-half of the connection period.

It is further within the scope of the fourth aspect of the invention to provide the above apparatus, wherein the two outermost connection locations on edges of each the module are spaced from nearest endpoints of each of the edge by up to one the connection period.

It is further within the scope of the fourth aspect of the invention to provide the above apparatus, wherein the connecting arrays have a connection period along the x-dimension at an connection period Pᵢₓ and along the y-dimension at an connection period P_{iy}.

It is further within the scope of the fourth aspect of the invention to provide the above apparatus, wherein the connection period in the x-dimension is a multiple of the positioning period in the x-direction (Pᵢₓ=mPₚₓ); and the connection period in the y-dimension is a multiple of the positioning period in the y-direction are equal (P_{iy}=nP_{iy}), wherein m and n are integers.

It is further within the scope of the fourth aspect of the invention to provide the above apparatus, wherein the x and y connection periods are equal and the x and y positioning periods are equal (Pᵢₓ=P_{iy}=Pi and Pₚₓ=P_{py}=Pₚ)

It is further within the scope of the fourth aspect of the invention to provide the above apparatus, wherein
a. each the module further comprises one or more arrays of sensors 107; the sensor arrays are disposed along edges of the rectangle, the edges oriented along at least one dimension of the rectangle, the sensors are periodically spaced along the edges in a dimension at a interface period of the dimension; and an output of each the sensor indicates whether or not the sensor is opposite another the sensor 107′ of another the module adjacent to the module along the edge of the sensor; tessellation extents of each the module in each the at least one dimension is an integer multiple of the interface period; and
b. the apparatus further comprises a main controller 120M configured to receive the sensor outputs;
   wherein the main controller 120M is further configured to compute tessellation extents of the tabletop in the one or more dimensions as a function of interface period and the sensor outputs.

It is further within the scope of the fourth aspect of the invention to provide the above apparatus, wherein the two outermost interface locations on edges of each the module are spaced from nearest endpoints of each of the edge by up to one-half of the interface period.

It is further within the scope of the fourth aspect of the invention to provide the above apparatus, wherein the two outermost interface locations on edges of each the module are spaced from nearest endpoints of each of the edge by up to one the interface period.

It is further within the scope of the fourth aspect of the invention to provide the above apparatus, wherein the interface locations are periodic in an x-dimension at an interface period Pᵢₓ and in a y-dimension at an interface period P_{iy}, the main module further configured to compute a shape of the tabletop.

It is further within the scope of the fourth aspect of the invention to provide the above apparatus, wherein the interface period in the x-dimension and the connection period in the x-direction are equal (Pᵢₓ=P_{cx}=P_{icx}); and the interface period in the y-dimension and the connection period in the y-direction are equal (P_{iy}=P_{cy}=P_{icy}).

It is further within the scope of the fourth aspect of the invention to provide the above apparatus, wherein the interface-connection x and y periods are equal (P_{icx}=P_{icy}=P_{ic}).

It is further within the scope of the fourth aspect of the invention to provide the above apparatus, wherein
d. each the module further comprises one or more detection interfaces; the detection interfaces occupy locations periodically spaced in one or more dimensions of the tabletop by an interface period of each the one or more dimensions, such that one or more pairs of the detection interfaces of the adjacent modules meet along the adjacent edges of the adjacent modules, the edges that comprise periodically spaced interface locations are oriented in one or more dimensions of the tabletop; each the pair of facing detection interfaces comprising at least one sensor; an output of each the sensor indicates whether or not the detection interface is facing a detection interface 107′ of an adjacent module; a tessellation extent of each the module along each the edge that comprises periodically spaced interface locations is an integer multiple of the interface period of the dimension;
e. the apparatus further comprises a main controller 120M configured to receive from each module the locations of one or more sensors facing a detection interface of a an adjacent module and the tessellation extents of the module, or codes associated therewith;
   wherein the main controller 120M is further configured to compute tessellation extents of the tabletop in the one or more dimensions as a function of the interface period and the sensor outputs.

It is further within the scope of the fourth aspect of the invention to provide the above apparatus, wherein the two outermost interface locations on edges of each the module are spaced from nearest endpoints of each of the edge by up to one-half of the interface period.

It is further within the scope of the fourth aspect of the invention to provide the above apparatus, wherein the two outermost interface locations on edges of each the module are spaced from nearest endpoints of each of the edge by up to one the interface period.

It is further within the scope of the fourth aspect of the invention to provide the above apparatus, wherein the interface locations are periodic in an x-dimension at an interface period Pᵢₓ and in a y-dimension at an interface period P_{iy}, the main module further configured to compute a shape of the tabletop.

It is further within the scope of the fourth aspect of the invention to provide the above apparatus, wherein the interface period in the x-dimension is an integer multiple of the positioning period in the x-dimension (Pᵢₓ=mPₚₓ); and the interface period in the y-dimension is an integer multiple of the positioning period in the y-dimension (P_{iy}=nP_{iy}).

It is further within the scope of the fourth aspect of the invention to provide the above apparatus, wherein the x and y interface periods are equal and the x and y positioning periods are equal (Pᵢₓ=P_{iy}=Pᵢ=mPₚₓ=nP_{py}=nPₚ; m=n)

It is further within the scope of the fourth aspect of the invention to provide the above apparatus, wherein each the module further comprises one or more connection arrangements 115 configured for attaching the adjacent modules; the connection arrangements are disposed along one or more edges of each the module, the edges oriented along at least one dimension of the rectangle, the connection arrangements are periodically spaced along the edges in a dimension at an connection period of the dimension; tessellation extents of each the module in each the at least one dimension is an integer multiple of the connection period.

It is further within the scope of the fourth aspect of the invention to provide the above apparatus, wherein the two outermost connector locations on edges of each the module are spaced from nearest endpoints of each of the edge by up to one-half of the connector period.

It is further within the scope of the fourth aspect of the invention to provide the above apparatus, wherein the two outermost connector locations on edges of each the module are spaced from nearest endpoints of each of the edge by one the connector period.

It is further within the scope of the fourth aspect of the invention to provide the above apparatus, wherein the connection locations are periodic in the x-dimension at a connection period P_{cx} and in the y-dimension at a connection period P_{cy}.

It is further within the scope of the fourth aspect of the invention to provide the above apparatus, wherein the interface period in the x-dimension and the connection period in the x-dimension are equal (Pᵢₓ=P_{cx}=P_{icx}); and the interface period in the y-dimension and the connection period in the y-dimension are equal (P_{iy}=P_{cy}=P_{icy}).

It is further within the scope of the fourth aspect of the invention to provide the above apparatus, wherein the interface-connection x and y periods are equal (P_{icx} P_{icy} Pic).

It is within the scope of a fourth aspect of the invention to provide any of the above apparatus, wherein the modules comprise a door-sliding mechanism for opening and closing of a door of a machine, wherein the main controller is configured to open the door before the receiving of the finished workpiece and to close the door after the feeding of the raw workpiece.

It is further within the scope of the invention to provide the previous apparatus, wherein the door-sliding mechanism further comprises two temporary stops mounted on the side of the frame, the temporary stops disposed at positions of an arm of the door-sliding mechanism at which the door is open and at which the door is closed; the main controller is further configured to calibrate the door-sliding mechanism by sliding open and closed the door-sliding mechanism detached from the door and recording the open and closed stop positions.

It is further within the scope of the invention to provide the previous apparatus, further comprising two temporary stops mounted on the side of the frame, the temporary stops emulating positions at which the door is open and at which the door is closed; the main controller is further configured to calibrate the door-sliding mechanism by sliding open and closed the door-sliding mechanism detached from the door and recording the open and closed stop positions.

### BRIEF DESCRIPTION OF THE DRAWINGS

It is understood that the figures in this disclosure, briefly described below, are not necessarily drawn to scale.

FIG. 1 shows a modular self-configuring tabletop apparatus, according to some embodiments of the invention.

FIG. 2 shows interconnected modules of a tabletop apparatus, comprising positioning arrangements for securing positions of workpiece-handling elements to the tabletop and connection arrangements for securing and co-positioning the modules relative to each other.

FIG. 3 shows details of positioning arrangements, positioning inserts, and bases for supporting workpiece-handling elements on plate modules of a tabletop apparatus, according to some embodiments of the invention.

FIGS. 4A-C show details of connection arrangements of modules of a tabletop apparatus, according to some embodiments of the invention.

FIGS. 5A-B show exploded views of adjacent modules of a tabletop apparatus, according to some embodiments of the invention, revealing detection interfaces of the modules.

FIG. 6A shows details of standard module types and FIG. 6B defines orientations of a standard module type.

FIG. 7 shows a non-limiting example of a functional layout of in a tabletop apparatus, including detection interfaces, according to some embodiments of the invention.

FIG. 8 shows a flow chart of a method for self-configuration of a tabletop apparatus, according to some embodiments of the invention.

FIG. 9 shows a tabulation constructed by a main controller in computing the geometry of a tabletop apparatus during a self-configuration method, according to some embodiments of the invention.

FIGS. 10A-I show various arrangements of tabletop apparatuses, according to some embodiments of the invention.

### DETAILED DESCRIPTION

Appendices A-C, pertaining to a self-configuration method according to some embodiments of the invention, is found at the end of this document after the drawing. The Appendices are incorporated in the disclosure.

### Definitions

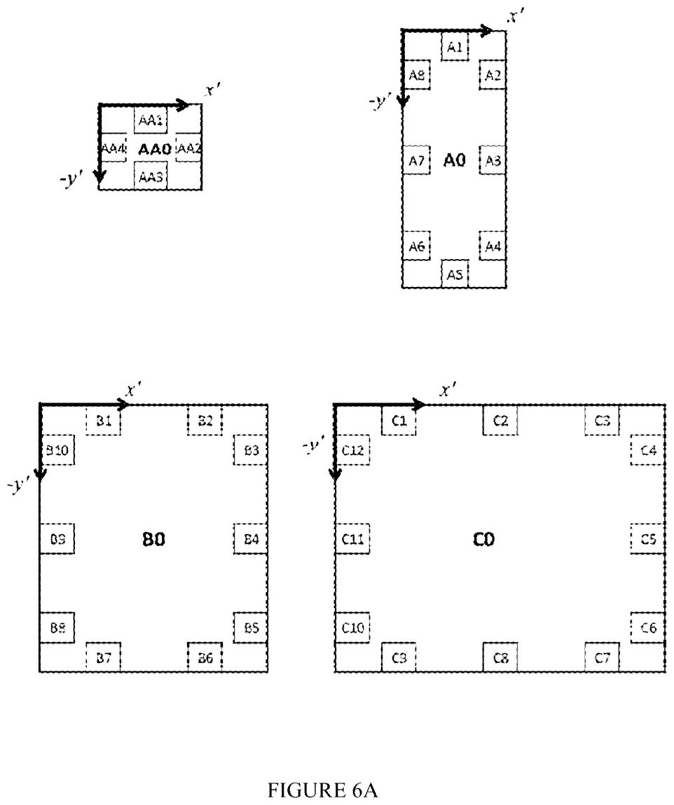

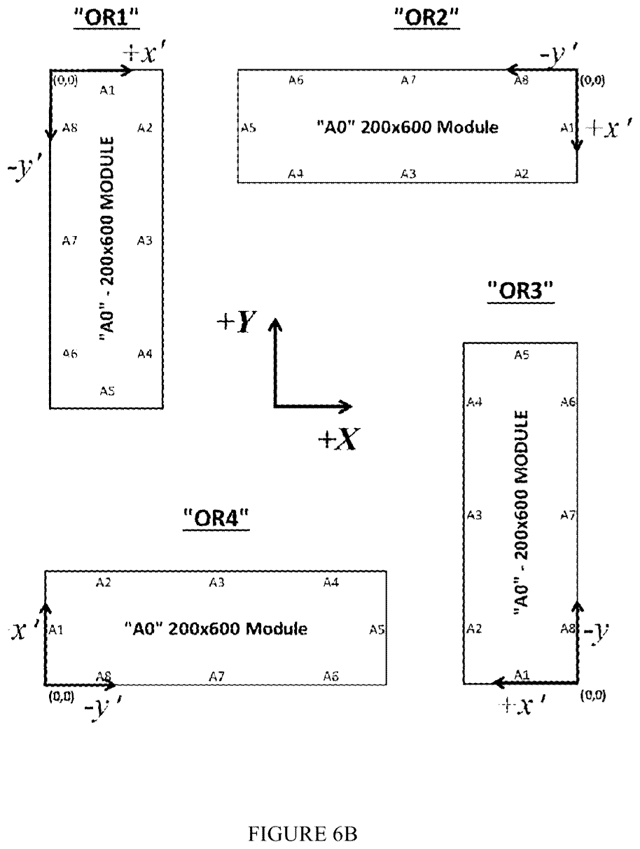

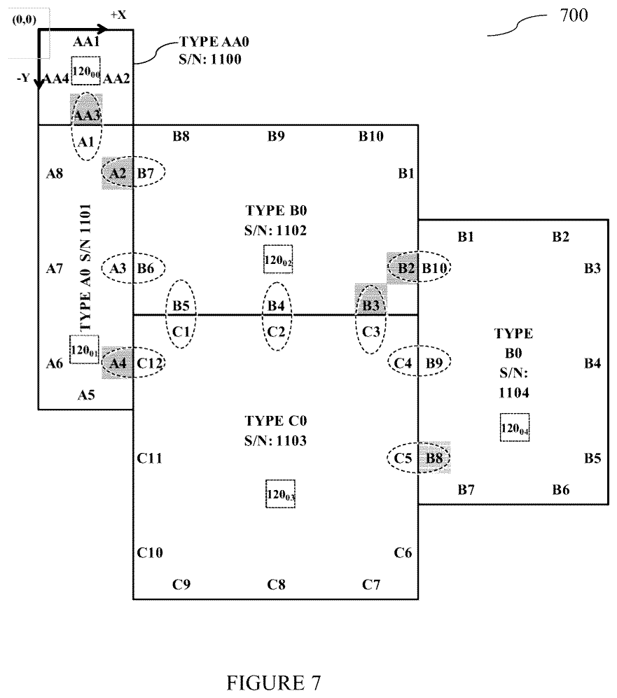

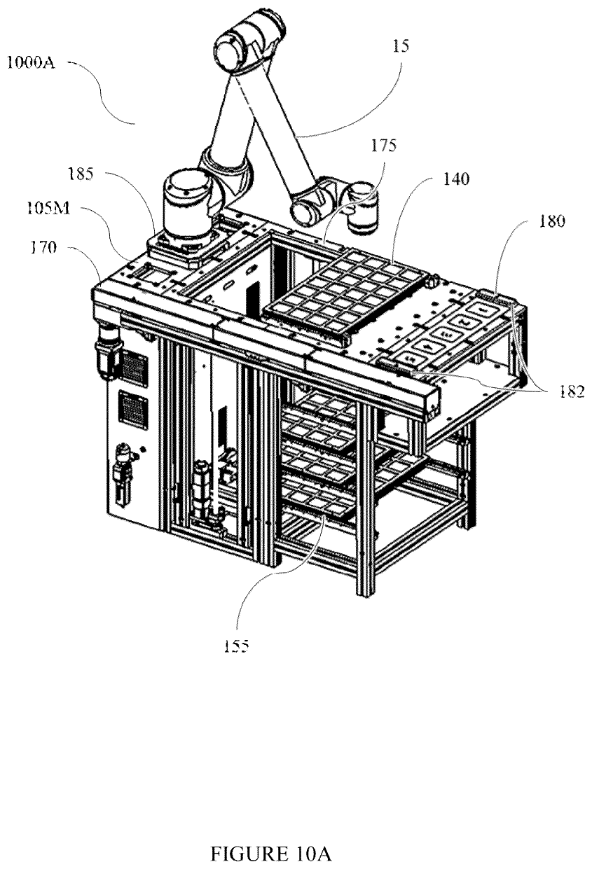

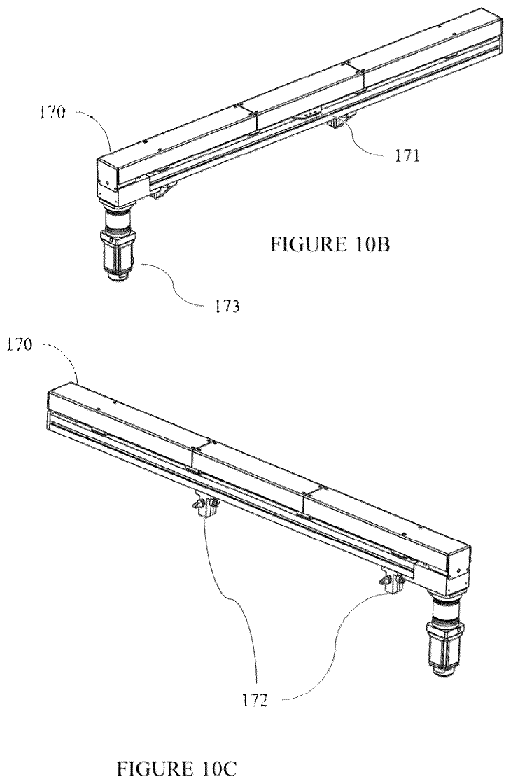

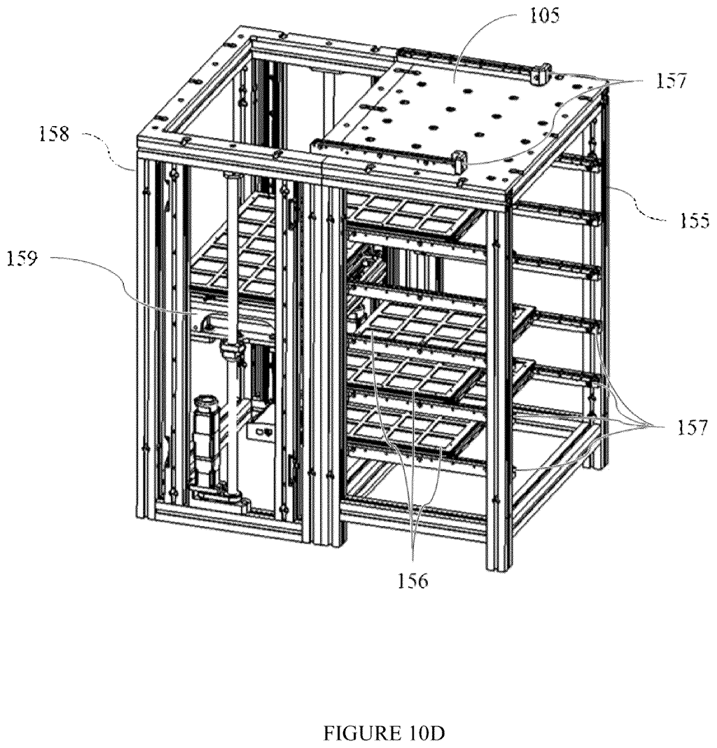

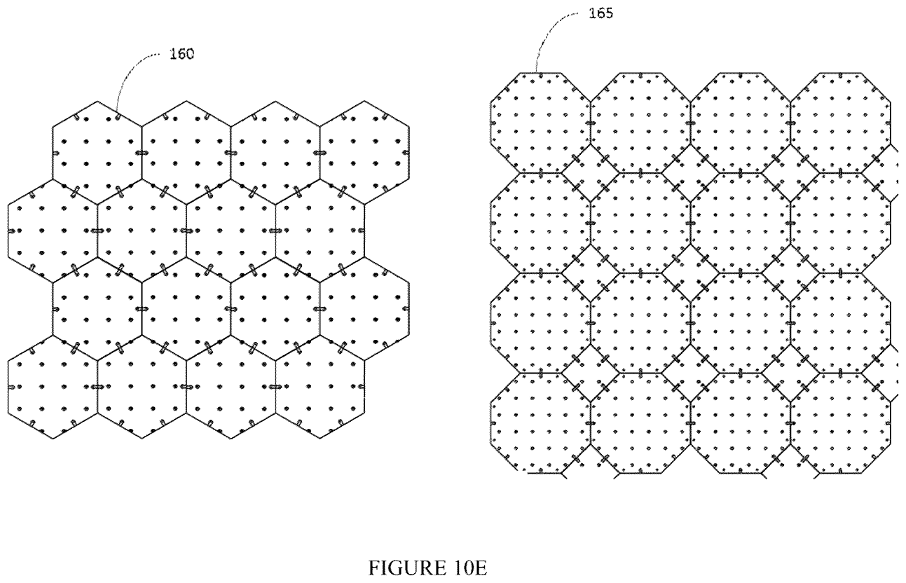

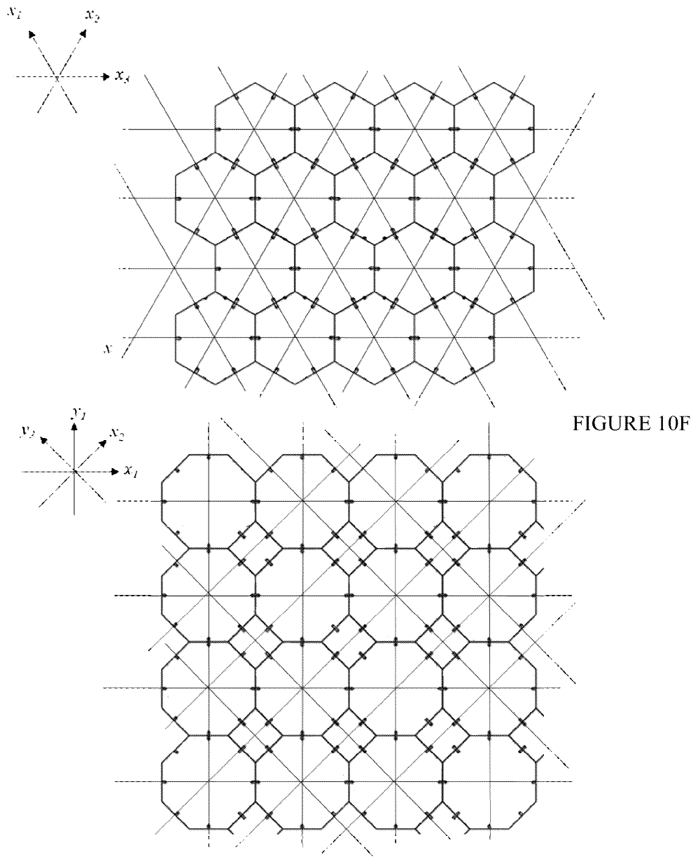

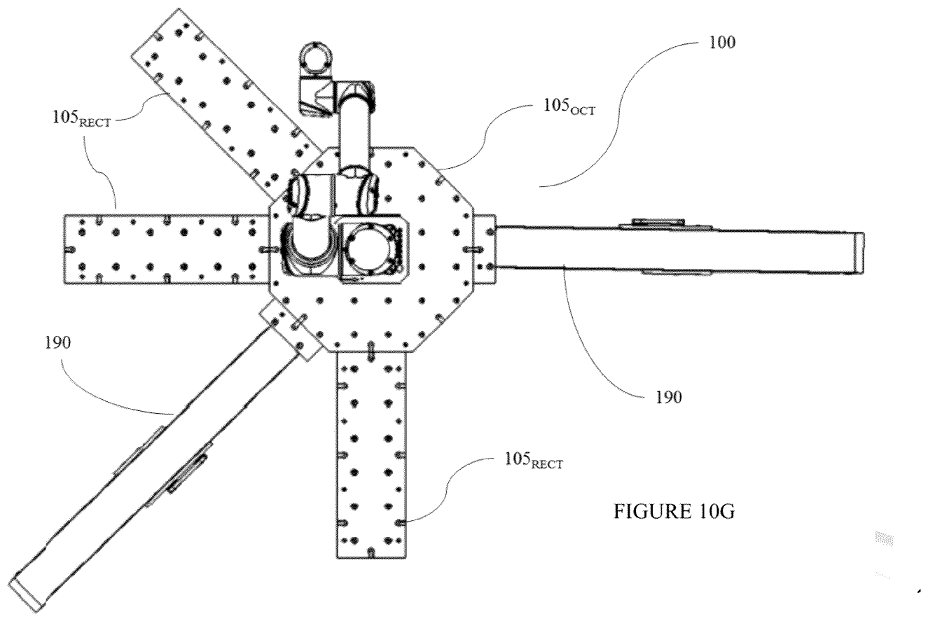

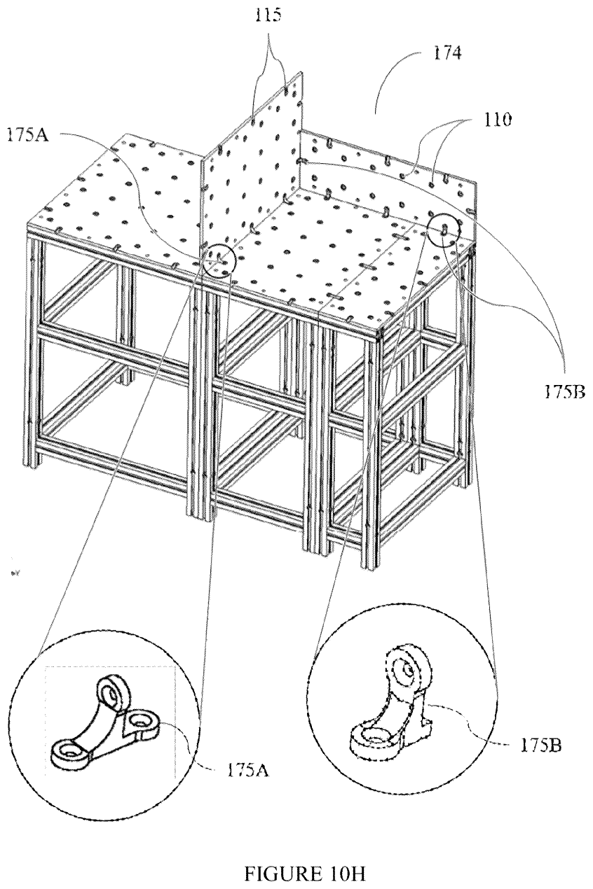

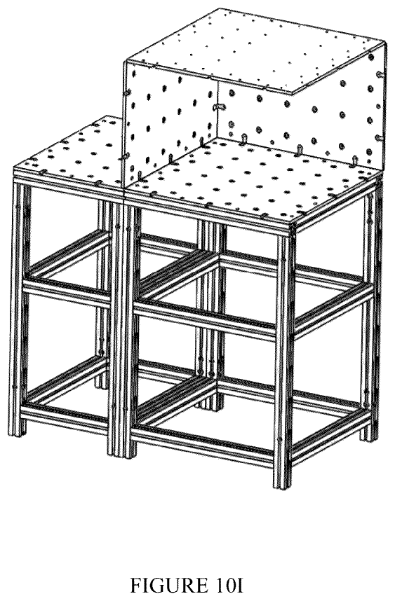

“Tabletop,” “tabletop apparatus,” or “apparatus” refers an arrangement and/or tessellation of modules, such as plates and workpiece-handling modules, forming one or more of horizontal surfaces (which may or may not be at the same height), shelves, and vertically oriented modules as well as modules positioned above the vertically connected modules. Additionally, tabletop or tabletop apparatus can include one or more module controllers, a main module, and a main controller; and in some embodiments can include equipment such as manipulators, grinding wheels, polishing wheels, assembly equipment, electronic testing equipment, automated measurement equipment, laser processing and marking equipment and other processing equipment.
“Module” refers to a plate or other apparatus that can be arranged with other modules by side-by-side placement along touching or parallel edges of the modules, horizontally, vertically and in angled position.
“Tessellation” is a surface occupied by an arrangement of a plurality of modules, whereby neighboring modules meet along at least a portion of their edges (meeting edges may be either in contact or with a gap between them).
“Dimension” refers to a particular spatial axis of a tabletop surface. In a tessellation of rectangular modules, there are two dimensions: x and y. In a tessellation of other polygonal modules, there may be additional dimensions (such as x′. y′, etc. shown in FIG. 10F).
“Extent” refers to a physical size in one of the dimensions.
“Module tessellation extent” is the physical extent (e.g., length or width) of the module plus the width of a gap (if any) between neighboring modules. In a tabletop apparatus, gaps between modules make an additional contribution to the overall size of the tabletop. In the invention, modules and their connection arrangements are periodically arranged such that their tessellation extents dimensions are an integer number of periods of periodic locations of at least one type of element (i.e., periodic locations of positioning arrangements, connection arrangements, and/or detection interfaces, as further described herein) in the tessellation.
“Adjacent module” refers to a neighboring module whose detection-interface locations and/or connection locations (as further described herein) are at corresponding points along meeting edges. Detection interfaces and/or connection arrangements at these locations are opposite each other and thereby configured to function intraoperatively, as further described herein.
“Consecutive module” refers to a neighboring module of, for example module “A,” whose detection-interface locations and/or connection locations continue the same periodicity as that of an edge of module A in the same directional orientation as the edge of module A. Depending on which embodiment of the invention, a consecutive module may or may not be an adjacent module, and vice-versa.
“Meeting edges” or “meeting sides” are edges or portions of edges of adjacent modules that are substantially in contact; or parallel (with a gap).
“Positioning arrangements” or “positioning grid” or “positioning array” refers to positioning features on modules, arranged as an array or grid with fixed distances between the positioning features. Positioning features will serve for accurately positioning workpieces, devices, robots, manipulators and other devices on the module and/or tabletop apparatus surfaces for positioning and in some cases also serve as fixation feature connecting various elements accurately positioned to the module/tabletop surface.
“Positioning period” or “positioning-location period” or Pₚ refers to the repeating distance in a tessellation between locations of arrangements for positioning of workpieces.
“Connection arrangements” refers to physical connection mechanisms to physically connect adjacent modules, and can provide an accurate alignment of one module to the other, as further described herein.
“Connection period” or “connection-location period” or P_{c} refers to the repeating distance in a tessellation between locations of arrangements for physical connection between modules.
“Detection interface” refers to a sensor, an emitter, a target, or a transceiver configured to interact with a facing detection interface of an adjacent module, at least one of the detection interfaces comprising an sensor, the facing detection interfaces providing for identification and/or communication between modules, as further described herein.
“Detection interface period” or “interface period” or “interface-location period” or Pᵢ refers to the repeating distance in a tessellation between locations of module detection interfaces.
“Meeting connections” or “opposite connections” refers to a pair of connection arrangements of adjacent modules directly across from each other.
“Facing interfaces” refers to a pair of detection interfaces of adjacent modules directly across from each other.
“Interface-connection” refers to a combination of a detection interface and a connection arrangement corresponding to the same edge locations in a in the connection and interface grids, as further described herein.
“Interface-connection period” or P_{ic} refers to the case where the detection-interface location period (Pᵢ) and the connection location period (P_{c}) are equal
“Absolute coordinate system” or “tabletop coordinates” or X-Y (capitalized) refers to the main coordinate system of a table top apparatus as shown in FIG. 7.
“Module axes” or “x′-y′ module axes” refers to the coordinate system attached to each module (i.e., rotating with module orientation). as, for example, shown in FIG. 6A and FIG. 6B.

(Where x and y are unprimed and uncapitalized, the meaning is clear from the context.)

Different elements of the invention described herein can be combined to construct an embodiment of the invention, even if the descriptions of the different elements are in different parts of the description and/or described with reference to different figures.

When describing an embodiment with reference to a figure, a reference number appearing in the description but not in the referenced figure refer to a same or equivalent element described in reference to the same number in a previous or later figure.

### Tabletop Apparatus

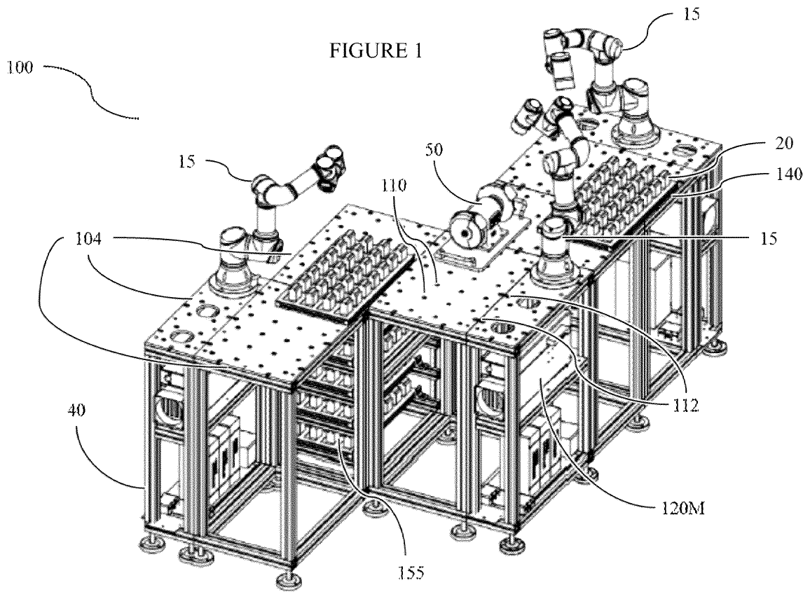

Reference is now made to FIG. 1, showing a modular self-configuring tabletop apparatus, according to some embodiments of the invention.

The invention relates to an industrial tabletop apparatus 100. The apparatus is constructed from modules 104, some of which can be rectangular plates as shown. The tabletop 100 is typically employed for positioning raw, semi-finished, and/or finished workpieces 20 and parts. The tabletop may be used during manufacturing, as well as after production for handling, testing, and packaging of parts, subassemblies, and finished products, as well as packing of products. In some embodiments, tabletop apparatus 100 is employed in a pick-and-place system, wherein robots or cobots 15 mounted on tabletop 100 handle workpieces 20. For example, a robot 15 picks raw workpieces from their loading positions on the tabletop 100 and places them into a workpiece chuck of a CNC machine (not shown) and retrieves finished workpieces from the chuck and moves them to a return position on the tabletop 100. Loading and return positions can be on a top surface of tabletop 100 (or along a vertically oriented module, further described herein), on a shelf of a tray magazine module 155 of tabletop apparatus 100, or on any modules or elements of apparatus 100. In addition to CNC machines, embodiments of the invention may be operable with an injection-molding machine, measurement instruments, surface-mount technology (SMT), an assembly line, a packaging line, printing equipment, laser marking and processing equipment, other processing and handling equipment, and combinations thereof.

The tabletop comprises one or more modules 104. A module 104 can be a plate or a particular workpiece-handling and/or processing apparatus such as a conveyor belt, a door opening mechanism for an adjacent industrial machine, an automated-lift-module, a QA station, a material bar magazine, a shelf module, a robot gripper station, a grinding or polishing wheel, a laser processing and marking device, a gripper adaptor and others. Embodiments of tabletops described herein comprise rectangular modules 104. However tabletop 100 may comprise modules shaped in any combination of shapes, including triangles, rectangles and other quadrilaterals, hexagons, and octagons.

Modules are typically supported by one or more support structures such as profile frames 40. One frame may support a number of modules 104 and/or frames may each support one module 104. Modules 104 may be connected by connecting arrangements 112, further described herein. Plate modules may comprise positioning arrangements 110, as further described herein, for accurate placement of workpiece-handling accessories on tabletop. Examples of workpiece-handling accessories include inlay trays 140 for pre-determinative placement of workpieces 20 on tabletop 100, a polisher 145 for polishing of workpieces 20, and a work piece alignment jig (not shown).

Additionally, in an aspect of the invention apparatus 100 comprises a main controller 120M and modules 104 comprise detection interfaces, as further described herein. The detection interfaces provide a novel method for self-configuration of the tabletop apparatus 100, wherein main controller 120M computes the overall shape and size of the tessellation of modules 104, as further described herein. (Main controller 120M can be mechanically proximate to the rest of apparatus 100, as shown, or can be remotely located, or can be a designated module controller of one of the modules 104. Main controller 120M can be connected to the rest of apparatus 100 via cable and/or wirelessly.)

The self-configuration method can provide a full map of modules 104 of apparatus 100 that are in one or more coordinate systems. The method defines the relationship of coordinate systems with each other—such as relative orientations of modules and change of planar dimensions when, for example, tabletop 100 comprises rectangular and hexagonal modules. The mapped coordinate systems can include coordinate systems of one or more robots, which can enable, for example, programming and maintaining positioning coordinates, including correct orientations of the robot arm on the tessellation of tabletop 100 and in relation to positioning arrangements and defined devices connected thereto; additionally, for example, in order for the robot arm to remain within defined boundaries in relation to tabletop 100. The mapping produced by the self-configuration method can enable visualization of the tessellation and position definitions for the elements, objects, devices, grippers, workpieces in relation to each other and in relation to the table top 100. Additionally, the map of modules' positions can help simplify setup, such as by computer GUI, of tabletop 100 and cobot 15 for a particular arrangement of workpieces 20, work-handling accessories, and industrial machines such as a CNC machine.

### Positioning Arrangements and Positioning-Location Period (Pₚ)

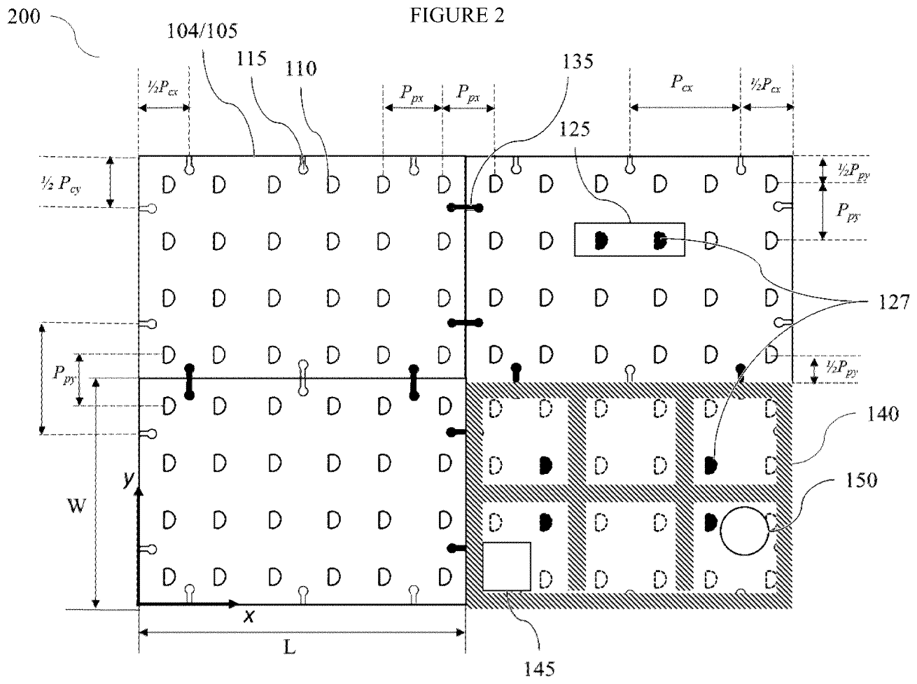

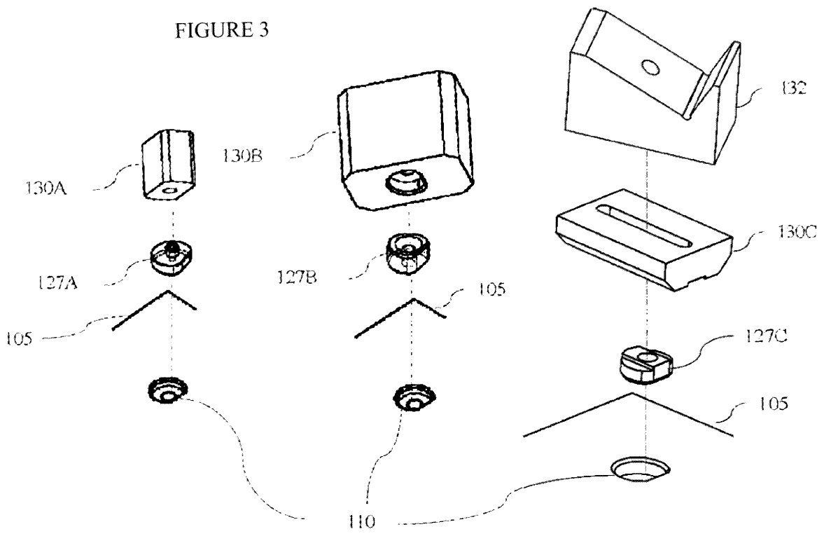

Reference is now made to FIG. 2, showing interconnected modules 104 of a tabletop apparatus 200, according to some embodiments of the invention. In some embodiments, modules 104 include rectangular plates 105 with positioning arrangements 110 thereon. Positioning arrangements 110 are indentations or protrusions in plate 105. Indentations can be, for example, threaded holes, bored holes, recesses, or any combination thereof. Protrusions can be, for example, bosses or pins, or any combination thereof.

Positioning arrangements 110 secure workpiece-handling elements and workpiece processing devices in accurate positions. In some embodiments, positioning arrangements 110 are disposed over a tessellation of one or more plates 105 of tabletop 200 at positioning locations periodically spaced in each of at least one dimension (e.g., x- and/or y-dimensions), at a positioning-location period Pₚ of the dimension. In some embodiments, one or more of the positioning locations on plates 105 are unpopulated by a positioning arrangement; for example, for modules 104 other than plates 105. Tessellation extents of modules 104 in each dimension with a positioning-location period (e.g. length L and/or width W) are discrete multiples of the positioning-location period of the dimension, assuring that periodicity of positioning locations is maintained for consecutive modules of a tessellation. Additionally, positioning locations can be periodic along both x and y dimensions; positioning-location periods in the x and y dimensions may or may not be equal. Equality of positioning-location periods in the x and y dimensions affords flexibility in tessellation geometry of plates, because rectangular plates may be added to a tessellation at any right-angle orientation without impairing the x and y periodicity of positioning locations. Such orientational invariance may be particularly exploitable if positioning arrangements 110 possess circular or rotational symmetry, as further described herein.

Furthermore, positioning locations on a plate 105 may be disposed on plate 105 such that there is up to half-period margins ½Pₚ between the outermost positioning locations and the nearest edge in a periodic dimension (half-period margins, with neighboring plates touching, is shown in FIG. 2). The margins are less than half-period if the tessellation is formed with gaps between plates, as in some embodiments. In other embodiments, there is up to a full-period standardized margins on both sides of each plate 105 between the outermost connection location and the nearest edge. A positioning location is thereby disposed at the middle of the gap between neighboring plates (or at the border of the two contacting plates 105, for full-period margins). The positioning location at the middle of the gap or border may be unpopulated by a positioning arrangement. Any of these schemes of disposition of positioning locations on plates assures that a reversed orientation (and if similarly implemented in both dimensions x and y dimensions, any right-angle orientation) of plate 105 does not impair the periodicity of positioning locations of consecutive modules in a tessellation. In yet other embodiments, there are unequal margins on either side, but the sum of neighboring margins of consecutive plates 105 does not exceed one full period.

Reference is now made to FIG. 3, showing details of positioning arrangements 110, positioning inserts 127A-C, and bases 130A-C for supporting workpiece-handling elements as needed, according to some embodiments of the invention. Positioning arrangements 110 comprise positioning recesses 110 in plates 105. In some embodiments, positioning recesses 110 are circular or have rotational symmetry. Circular shapes of positioning recesses 110 provide rotational freedom of positioning insert 127, while other symmetric shapes provide flexibility in placement orientation. In other embodiments, positioning recesses are rotationally non-symmetric; for example, having the shape of a circular segment (e.g., a semi-circle or a “D” shape, as shown), two non-congruous circles, an imbalanced ellipse, or any combination thereof. Non-symmetric shapes of positioning recesses can help, for example, to avoid orientational errors where placement orientation of positioning inserts 127A-C connected to workpiece handling elements or workpiece processing devices on plates 105 is important for rotational positioning purposes or are subject to human error.

Various types of positioning inserts 127A-C can be inserted in the positioning recesses 110. Positioning inserts 127A-C retain workpiece-handling bases 130A-C and elements mounted thereon in position. Workpiece handling elements can be supported by bases 130A-C. Insert/base combinations 127A-127C/130A-130C, respectively, are task-specific: combination A is employed for rectilinear-only restriction and rotational freedom of base 130A about positioning insert 127A; combinations B and C are employed for both rectilinear and rotational restriction of bases 130B-C. Combination C permits one-axis pre-alignment and locking of a rectilinear position. A pre-alignment capability permits easier mounting, for example, of a workpiece alignment jig 132, which can be aligned along the slot 128 during setup of the workpiece process. In some embodiments, the positioning recess 110, positioning insert 127A-C and/or base 130A-C are bored or threaded, for securing the base 130A-C to plate 105.

### Connection Arrangements and Connection-Location Period (P_{c})

Reference is now made again to FIG. 2. In some embodiments, modules 104 of tabletop apparatus 200 comprise connection arrangements 112 for securing and/or accurately co-positioning neighboring modules of tabletop 200. Connecting arrangements 112 are connectors that can be, for example, latches and/or bridge fasteners. In some embodiments, positioning arrangements 110 on both neighboring plates may be used to secure anchors of a bridge fastener. In various embodiments, connection arrangements 112 are disposed above or embossed into the surface of module 104, along the edge of module 104, underneath module 104, such as in a a support structure supporting a module 104, or any combination thereof.

A pair of opposite connection arrangements 112 of adjacent modules 104 enable a connection across edges of adjacent modules, at a connection location of the edges.

In some embodiments, connection arrangements are disposed over a tessellation of one or more modules 104 of tabletop 100 at connection locations periodically spaced in at least one dimension (e.g., x-and/or y-dimensions), at a connection-location period P_{c} of the dimension. In some embodiments, one or more of the connection locations are unpopulated by connection arrangements; for example, connection locations within the interior surface of a module 104 are unpopulated by connection arrangements. Tessellation extents of modules 104 in each dimension with a connection-location period (e.g. length L and/or width W) are discrete multiples of the connection-location period of the module tessellation extent dimension, assuring that periodicity of connection locations is maintained for consecutive modules of a tessellation. Additionally, connection locations can be periodic along both x and y dimensions; connection-location periods in the x and y dimensions may or may not be equal. However, equality of connection-location periods in the x and y dimensions affords orientational flexibility in tessellation of modules, because rectangular modules may be added to a tessellation at any right-angle orientation without impairing the x and y periodicity of connection locations.

Furthermore, connection locations on a module 104 may be disposed along edges of module 104 such that there is up to half-period spacing ½P_{c} between the outermost connection locations and the nearest edge endpoint in a periodic dimension (half-period spacing, with consecutive modules touching, is shown in FIG. 2). The spacing is less than half-period spacing if the tessellation is formed with gaps between consecutive modules, as in some embodiments. In other embodiments, there is up to a full-period standardized spacing to both endpoints between the outermost connection location and the nearest edge. A connection location is thereby disposed at the middle of the gap between neighboring plates (or at the border of the two contacting plates 105, for full-period margins). The connection location at the border may be unpopulated by a connection arrangement. Any of these schemes for disposition of positioning locations on modules 104 assures that a reversed orientation (and if similarly implemented in both x and y dimensions, any right-angle orientation) of module 104 does not impair the periodicity of positioning locations of consecutive modules in a tessellation. The advantage of module-orientation invariance (of continuing connection-location periodicity) is enhanced by the connection arrangements 112 possessing bilateral or rotational symmetry, as further described herein. In yet other embodiments, there is unequal spacing to either edge endpoint, but the sum of neighboring spacings does not exceed one full period.

In some embodiments, modules with positioning arrangements form a tessellation comprising connection-location periods in the x- and y-dimensions of Pₚₓ and P_{py}, respectively (for non-rectangular modules, there may be a different number of dimensions, oriented one or more non-perpendicular directions, as further described herein, including in connection with FIGS. 10E-10G). The tessellation further comprises connection-location periods in the x- and y-dimensions of P_{cx} and P_{cy}, respectively. By virtue of a tessellation extent of a module being integer multiples of its positioning-location and connection-location periods, the two periods have a ratio of the two integer multiples (e.g., if a module's tessellation extent is three times the positioning-location period Pₚ and twice the connection-location period P_{c}, then the ratio P_{c}/Pₚ=3/2). In some embodiments, the x connection-location period is a multiple of the of the x positioning-location period (P_{cx}=mPₚₓ, where m is a positive integer) and the y connection-location period is a multiple of the of the y positioning-location period (P_{cy}=nP_{py}, where n is a positive integer); these relationships allow plates 105 to be cut, in their x and y tessellation extents, to any integer multiple of the connection-location periods without impairing positioning- and connection-location periodicities. (In other embodiments, the positioning-location periods are a multiple of the connection-location periods; these relationships allow plates 105 to be cut to any integer multiples of the positioning-location periods without impairing positioning- and connection-location periodicities.) Moreover, in some embodiments the x and y periods are equal (P_{cx}=P_{cy}, Pₚₓ=P_{py} and m=n), enabling invariance of both the positioning-location and connection-location periodicities to rotational orientation of the plates. Preferably, positioning locations and connection locations coincide, for every mth positioning location. Alternatively, positioning locations and connection locations are shifted in phase.

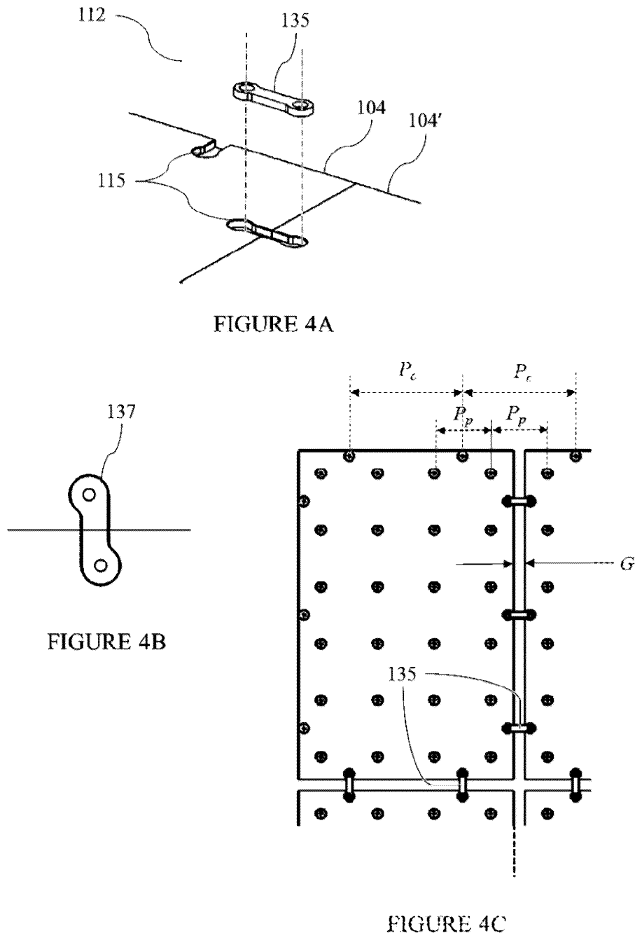

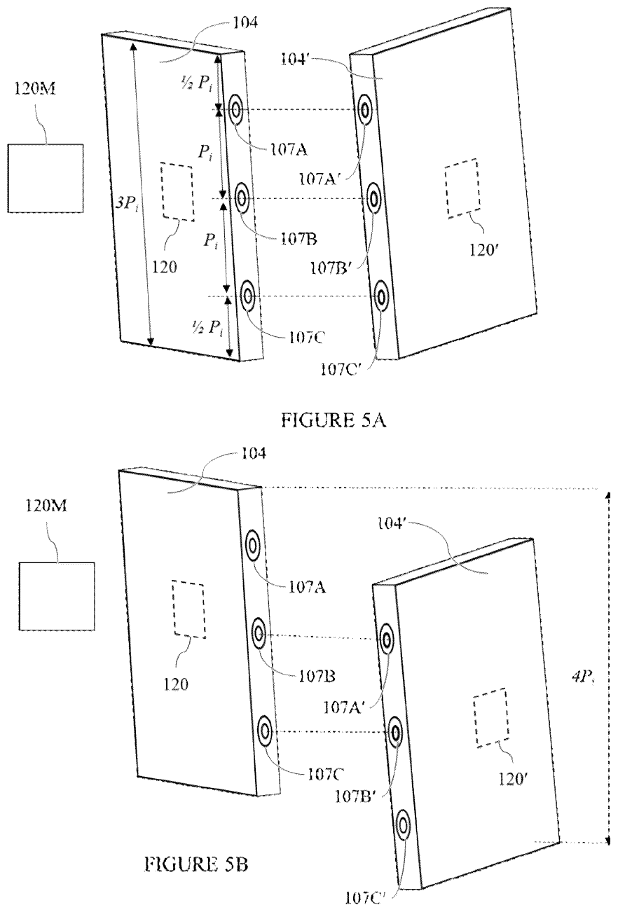

Reference is now made to FIG. 4A, showing details of a connection arrangement 112, according to some embodiments of the invention. Connecting arrangement comprises a connection recess 115 reaching an edge of a module 104. Connection recess 115 of the edge and a facing connection recess of an edge of an adjacent module 104′ form an interlocking shape. The combined interlocking shape of facing connection recesses receives a connection insert 135 having substantially the same interlocking shape or a shape with surfaces that that through positioning the connection insert 135 into the recess 115 securing accurate positioning in at least two axis's is secured, typically x and y direction between adjacent modules 104 and 104′. Connection insert 135 fits into the facing recesses to enable interlocking and positioning of modules 104. The interlocking shape can be a “dogbone shape,” as shown, or any other interlocking shape such as a barbell, an X, inverted Y's, a double arrow, connected shapes such as triangles or trapezoids, or any combination thereof. Connection recesses 115 and connection insert 135 can be bored and/or threaded, for fastening connection insert 135 to adjacent modules 104, 104′. One or more connection inserts 135 secured to connection recesses 115 provide a secure inter-connection of adjacent modules 104, 104′.

In some embodiments, interlocking shapes possess bilateral symmetry, as does connection insert 135, or rotational symmetry, as does connection insert 137 in FIG. 4B. Such symmetry permits a uniform shape of connection recesses 115 throughout the tabletop and fit of connection inserts 135 or 137 for all orientations of connection recesses 115.

An advantage of the connection recess approach is ease of replacement of a module 104. A module 104 can be inserted and secured with installation work performed above the apparatus. Additionally, modules can be installed and removed without a need to disassemble surrounding modules in the tessellation: connection inserts and fasteners are inserted and removed above the module, so removal and insertion of modules is thereby made easily accessible.

In embodiments according to FIG. 4C, modules 104, connection recesses 115, and/or inserts 135 can be appropriately sized for gaps of G between modules (such as when the margin between the outermost connection recess 115 and physical edge of module 104 is less than one-half a connection period or between one-half and one period), while maintaining positioning-location and connection-location periodicities across consecutive modules. The gap might be functional and can allow fingers or lifting equipment to remove and insert modules, further simplifying module replacement.

### Detection Interfaces and Interface-Location Period (Pᵢ)

Reference is now made to FIG. 5A, illustrating an exploded view of adjacent modules 104 and 104′ of a tabletop, according to some embodiments of the invention. The modules are disassembled and their edges are rotated to reveal detection interfaces 107A-C of module 104 and 107A′-C′ of module 104′.

Detection interfaces 107A to 107C of module 104 are disposed across from detection interfaces 107A′ to 107C′, respectively, of module 104′. When modules 104 and 104′ are assembled, detection interface 107A is facing 107A′, 107B is facing 107B′, 107C is facing 107C′. Detection interfaces 107A-C can be embedded into the edge of module 104 (as shown), disposed below the surface of a module (such as attached to a support structure), disposed above the surface of a module, or any combination thereof.

Each pair of facing detection interfaces comprises at least one sensor. In some embodiments, an output of the sensor indicates whether or not (1 or 0) the detection interface 107A of module 104 (for example) is facing an adjacent module (adjacent edges are in contact or, in other embodiments, directly across a gap). In some embodiments, an output of the sensor indicates whether or not the detection interface 107A of module 104 (for example) is facing another detection interface of an adjacent module. Examples of suitable types of sensors include micro-switches, RFID cards, proximity sensors, optical sensors, RF transceivers, magnetic sensors, and any combination thereof.

A pair of facing interfaces, 107A and 107A′ (for example), may or may not be identical. For example, one may be a sensor and the other a target of a material and construction making it detectable by the sensor. Alternatively, both 107A and 107A′ can each comprise a sensor and a target (e.g., alongside each other), allowing for universal connectivity of interface sensors (i.e., without concern about matching sensor detection interfaces with target detection interfaces). In some embodiments, the detection interface comprises an optical transmitter and receiver (e.g., OPB733TR; Optek Technologies; Carrollton, Texas), enabling exchange of data between detection interfaces, in addition to the sensing feature. In some embodiments, detection interface 107A (for example) transmits information about module 104 (e.g. dimensional extents of module 104) and the position of detection interface 107 relative to module 104 (or identifiers attesting thereto) and/or receives from detection interface 107A′ information about module 104′ and the position of detection interface 107 relative to module 104 from facing detection interface 107A′.

Detection interfaces may be periodically disposed at an interface-location period Pᵢ, as further described herein. In FIG. 5B, adjacent module 104′ is shifted relative to module 104 by one period. In this simplified example, main controller 120M receives a detection sequence (0, 1, 1) from detection interfaces 107A-C and sequence (1, 1, 0) from detection interfaces 107A′-C′, respectively. Main module 120M determines that the overall extent of modules 104 and 104′ is four interface-location periods, or 4Pᵢ.

In some embodiments, sensors are full-duplex transceivers, for example an optical emitter/detector pair. Furthermore, modules 104 may comprise controllers 120, 120′ connected to the transceivers, permitting storage and communication of information—such as dimensional extents of modules and relative positions of identified transceivers—between adjacent modules 104, 104′ through the transceivers. Controllers and communication between them can enable configuration and operation of a local-area network of modules, as further described herein.

A pair of facing detection interfaces, for example 107A and 107A′, enables determination by a main controller 120M connected to at least one of detection interfaces 107A-107A′, that interface locations along corresponding edges of modules 104 and 104′ are at a common interface location of the tessellation. This determination, made over all modules in a tessellation area of the tabletop, enables main controller 120M to compute the size and shape of the tessellation area, as further described herein.

In some embodiments, detection interfaces are disposed over a tessellation of one or more modules 104 of a tabletop at interface locations periodically spaced in at least one dimension (e.g., x- and/or y-dimensions), at an interface-location period Pᵢ of the dimension. In some embodiments, one or more of the interface locations are unpopulated by a detection interface; for example, within the interior surface of a module 104. Tessellation extents of modules 104 in each dimension with an interface-location period are discrete multiples of the connection-location period of the dimension, assuring that periodicity of interface locations is maintained for consecutive modules of a tessellation. Additionally, interface locations can be periodic along both x and y dimensions and x′ and y′ of P_{ix′} and P_{iy′} respectively in tessellations utilizing also non rectangular table tops and modules (FIG. 10D to 10F); interface-location periods in the x and y dimensions may or may not be equal. In tessellations utilizing non rectangular table tops and modules Pᵢₓ and P_{ix′} might not be equal, and same for P_{iy} and P_{iy′}. Equality of interface-location periods in the x and y dimensions affords flexibility in tessellation of modules, because rectangular modules may be added to a tessellation at any right-angle orientation without impairing the x and y periodicity of interface locations.

Furthermore, interface locations on a module 104 may be disposed along edges of module 104 such that there is up to half-period spacing ½Pᵢ between the outermost interface locations and the nearest edge endpoint in a periodic dimension (half-period spacing is shown in FIGS. 5A-B). The spacing is less than half-period spacing if the tessellation is formed with gaps between consecutive modules, as in some embodiments. In other embodiments, there is up to a full-period standardized spacing to both endpoints between the outermost interface location and the nearest edge. An interface location that might or might not be implemented is thereby disposed at the middle of the gap between neighboring plates (or at the border of the two contacting plates 105, for full-period margins). The interface location at the border may be unpopulated by a detection interface. Any of these schemes for disposition of interface locations on modules 104 assures that a reversed orientation (and if similarly implemented in both x and y dimensions, any right-angle orientation) of module 104 does not impair the periodicity of interface locations of consecutive modules in a tessellation. In yet other embodiments, there is unequal spacing to either edge endpoint, but the sum of neighboring spacings does not exceed one full period.

In some embodiments, modules with connection arrangements form a tessellation comprising connection-location periods in the x- and y-dimensions of P_{cx} and P_{cy}, respectively. The tessellation further comprises interface-location periods in the x- and y-dimensions of Pᵢₓ and P_{iy}, respectively. In some embodiments, the x connection-location period is equal to the x interface-location period (P_{cx}=Pᵢₓ) and the y connection-location period is equal to the y positioning-location period (P_{cy}=P_{iy}); these relationships allow plates 105 to be cut, in their x and y tessellation extents, to any integer multiple of the connection-location periods without impairing positioning- and connection-location periodicities. Moreover, in some embodiments the x and y periods are equal (P_{cx}=Pᵢₓ=P_{cy}=P_{iy}), enabling invariance of both the interface-location and connection-location periodicities to rotational orientation of the plates. Preferably, interface locations and connection locations coincide. Alternatively, interface locations and connection locations are shifted in phase or ½ period.

In some embodiments, connecting arrangements 112 and/or sensor interfaces 107 may disposed in the frame or structural support of the module, rather than inside the plates of the plate modules or at such a vertical level of other modules.

### Detection and Self-Configuration Method

A non-limiting example of self-configuration of a tabletop apparatus is now described. The example is given for modules 104 selected from a non-limiting example of a set (AA0 and A0-F0) of standard module types, described in Table 1 and illustrated in FIG. 6A. Detection interfaces are periodically disposed at an interface-location period (Pᵢ) of 200 mm in both x and y dimensions. In preferred embodiments, modules have equal x- and y-dimension connection-location periods (P_{c}) equal to interface-location period (Pᵢ). In more-preferred embodiments, detection interfaces and connection arrangements are additionally at the same locations with respect to module edges.

TABLE 1

| | | | Number of | | Distance |
|---|---|---|---|---|---|
| | | | det. interface | | from |
| Module | Width | Length | periods along | | Edge |
| Type | (mm) | (mm) | Width | Length | (periods) |
| AA0 | 200 | 200 | 1 | 1 | 0.5 |
| A0 | 200 | 600 | 1 | 3 | 0.5 |
| B0 | 400 | 600 | 2 | 3 | 0.5 |
| C0 | 600 | 600 | 3 | 3 | 0.5 |
| D0 | 800 | 600 | 4 | 3 | 0.5 |
| E0 | 1000 | 600 | 5 | 3 | 0.5 |
| F0 | 1200 | 600 | 6 | 3 | 0.5 |

Detection interfaces 107 are assigned interface identifiers: for example, module type A0 has detection interface identifiers A1-A8, assigned clockwise from the x′y′ origin (by prescribed convention; they can be any other defined order).

When module in the set are tessellated, the module edges are in contact; therefore the tessellation extents equal the module extents (i.e., no gaps). The modules have x′ extents (widths) and y′ extents (lengths) that are integer multiples of the interface-location period (Pᵢ). Each module type has an x′y′ Cartesian coordinate plane. The module origin of each module type is defined by convention to be at the corner to the left to the first detection interface (A1, B1, etc.), as shown in FIG. 6A. Each detection interface of a module type has known module x′y′ coordinates (which may be stored in the module controllers and/or main controllers, as further described herein). For example, the module coordinates of interface B4 are (+2, −1.5) in interface periods, which are (+400, −300) in millimeters.

FIG. 6B shows module type A0 in four rotational orientations, OR1-OR4. When modules are arranged in a tessellation (e.g., as shown in FIG. 7), the orientation of a module determines how an offset—in the X-Y tabletop (absolute) coordinates—between a module x′y′ origin and an interface location is computed. For an interface with module coordinates (x″, y″), the X-Y tabletop offset of the interface from the module origin is given by the following function of the orientation:

| | Offset from |
|---|---|
| | module x′y′ |
| Orientation | origin |
| OR1 | (x″, y″) |
| OR2 | (y″, −x″) |
| OR3 | (−x″, −y″) |
| OR4 | (y″, −x″) |

For example, interface A2, with interface A0 coordinates (1, −½), is offset (in interface periods) from the A0 origin by (1, −1/2) for an A0 orientation of OR1; (−½, −1) for OR2; (−1, +½) for OR3; and (+½, +1) for OR4.

In this example, detection interfaces 107 each comprise an infrared transceiver, configured for two-way communication with a facing detection interface transceiver 107′. Each module contains a module controller 120 communicatively connected to the infrared transceivers of the module. Module controllers comprise a memory storing identifying information, such as a module identifier and module type and additional storage space as required for storing data regarding adjacent modules discovered during self-configuration. Module controllers may further store data related to workpiece handling. In some embodiments, the memory of a module controller stores the actual size (in length units or number of periods) of the module and/or a table of interface positions; which may be used, for example, in modules with non-standard configurations or in tabletops where modules with non-standard configurations may be introduced.

Reference is now made to FIG. 7, showing a non-limiting example of a functional layout of a tabletop apparatus 700, including detection interfaces 107, according to some embodiments of the invention. Example apparatus 700 comprises five modules 104 selected from the set of module types in Table 1. Modules have serial numbers 1100-1104. When placed in a tabletop apparatus, adjacent modules are co-disposed such that one or more transceivers of one of the modules each faces a transceiver of the adjacent module. Controllers 120₀₀-120₀₄ of the adjacent modules may communicate through these facing transceivers. The facing-transceivers alignment condition may be enforced by periodic connection arrangements of the modules, further described herein.

Modules controllers 120₀₀-120₀₄ are interconnected through a network dedicated to the apparatus 700. In some embodiments, network links between module controllers 120₀₀-120₀₄ are established by communication through the transceivers of detection interfaces 107. In other embodiments, the dedicated network linking between module controllers 120₀₀-120₀₄ may be a wireless network, such as a WiFi network. In yet other embodiments, the network may be a cabled network, such as an Ethernet cabled network. In embodiments of this example, the dedicated network is a wireless network. Access to the dedicated network is restricted to modules 104 of apparatus 700. The dedicated network is employed for a self-configuration method of tabletop apparatus 700, as further described herein. Additionally, the network may also be employed for control and monitoring of workpiece-handling modules and workpiece-handling accessories and/or workpiece processing devices/equipment positioned on modules of apparatus 700.

In this embodiment, module S/N 1100, of type AA0, is the main module. The main module 1100, by the convention used in this example, has an orientation of OR1. Furthermore, the origin of the X-Y tabletop coordinate system is the same as the module x′y′ origin of module 1101. The tabletop X-axis is co-linear with the main module x′ axis and the tabletop Y-axis is co-linear with main module y′ axis. The main module 1100 comprises a main controller 120₀₀. Main controller 120₀₀ is responsible for initiating the configuration method, computing the shape and size of tabletop 700, and controlling access to the wireless network. In other embodiments, main controller 120₀₀ may be a module controller (i.e., belong to a designated module, as shown in FIG. 7) or may be an external computer, in communicative connection with at least one of the module controllers, disposed at any location with respect to the other modules of the tabletop apparatus.

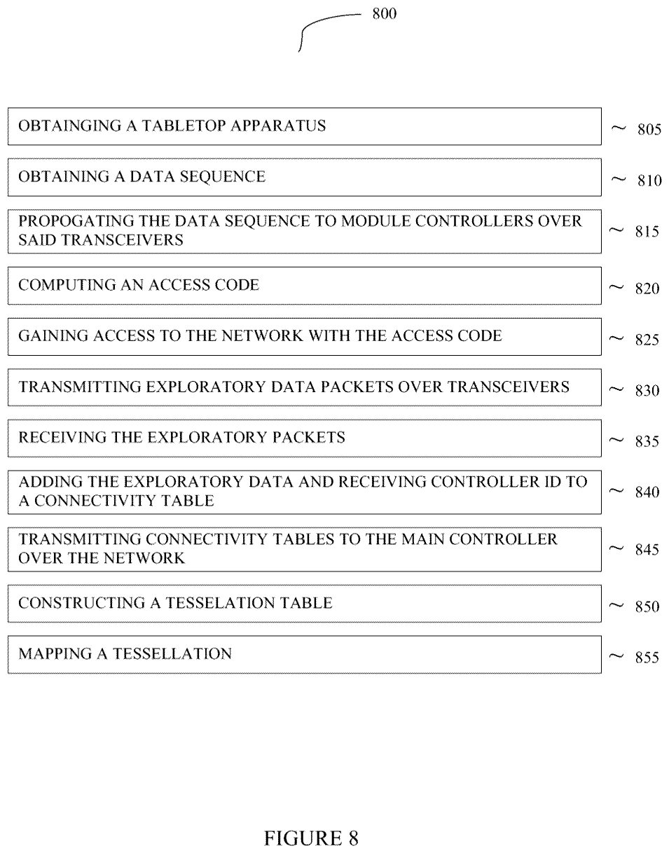

Reference is now also made to FIG. 8, showing a flow chart of a self-configuration method 800. We describe method 800 in reference to apparatus 700 in FIG. 7. A configuration procedure 800 of apparatus 700 occurs, for example, after power-up of apparatus 700. In some embodiments, power may be supplied to controllers from a central power supply through electrical connectors between modules. Alternatively, module controllers are supplied by cables connected to module controllers by an electrical connector disposed, for example, underneath modules.

In the description of some steps of the method, reference is made to redundancy and minimal data options of configuration. It is appreciated the two options have opposing design goals, and that a method with of redundancy and/or data minimization, in any combination, are included in the teachings of the invention.

Self-configuration 800 comprises main controller 120₀₀ obtaining (e.g., computing, randomly generating, or fetching) a data sequence associated with an access code of to be used by each module controller 120₀₁-120₀₄ to gain access to the network 810. The data sequence may be randomly generated or may be a function of a number associated with main controller 120₀₀, such as its serial number.

Self-configuration 800 further comprises main controller 120₀₀ propagating the data sequence to the other modules 120₀₁-120₀₄ 815 over the transceivers. Data sequence propagation 815 may employ protocols and/or algorithms (which are programmed in controllers 120₀₀-120₀₄) known in the art for node discovery and network broadcasting.

Self-configuration 800 may further comprise each module controller computing an access code to the network using a pre-defined algorithm 820. The access code of each controller 120₀₁-120₀₄ is a function of at least the data sequence received from main controller 120₀₀. In some embodiments, each controller 120₀₁-120₀₄ computes the same access code from the data sequence. In some alternative embodiments, the access code of each controller 120₀₁-120₀₄ is a function of the data sequence and a number associated with a controller 120₀₁-120₀₄, such as its module serial number 1101-1104. In some embodiments, the access code is further encrypted and/or comprises a challenge. Step 820 is an optional security feature; in other embodiments, the access code that will be used by each module to access the network is the same as the data sequence originating from main controller 120₀₀.

Self-configuration 800 further comprises module controllers 120₀₁-120₀₄ gaining access to the network 825, each using its access code. In some embodiments, gaining access 825 comprises passing module serial numbers, in order for main module 120₀₀ to confirm that each module 120₀₁-120₀₄ calculated its correct access code from its serial number. Upon gaining access to the network 825, module controllers 120₀₁-120₀₄ are thereafter enabled to communicate with main controller 120₀₀ over the network. In some embodiments, one or more of module controllers 120₀₁-120₀₄ are further enabled to communicate directly with each other over the network.

Gaining access with an access code 825 helps to prevent inadvertent or malicious connection to the network by modules or computing devices not connected to apparatus 700. This protection is particularly important if the network is a wireless network, as in the vicinity of tabletop 700 there may be unconnected modules of other tabletop apparatuses or malicious nodes that may attempt to access the network.

Self-configuration 800 further comprises each module controller 120₀₁-120₀₄ (in some embodiments, including all controllers 120₀₀-120₀₄) transmitting an exploratory data packet over each of its transceivers 830. The exploratory data packet comprises a module identifier (for example, serial number, e.g. 1100, 1101, etc.), module type (e.g. AA0, A0, B0, etc.), and interface address (e.g., AA1-AA4, A1-A8, B1-B10, etc.) of the detection interface of each transmitting transceiver. Exploratory data packets over each of a module's interface transceivers may be made simultaneously or scanned in some order, such as clockwise: AA1, AA2, AA3, AA4; A1, A2 . . . , A8; etc.; or in any predeterminate order. In some other embodiments, a module's controller may send exploratory packets in a random order of interface transceivers.

Modules 120₀₁-120₀₄ may all transmit exploratory data packets simultaneously or in some order determined by an algorithm known in the art, for example.

Where the transmitting transceiver is facing a transceiver of a neighboring module, the neighboring module receives the exploratory packet through the facing transceiver of the neighboring module 835. For example, interface transceiver B7 of module 1102 receives an exploratory packet from interface transceiver A2 of module 1101. (In FIG. 7, facing pairs of interfaces are encircled.) Where no transceiver is facing the transmitting transceiver (e.g. at the edge of tabletop 700, as in interface B1 of module 1102), the transmission is undetected and results in no further action.

Self-configuration 800 further comprises each neighboring module's controller adding the exploratory packet data and the identifier of the receiving transceiver of the neighboring module to a connectivity table 840. One of the connectivity tables, that of module 1102, is shown in Table 2.

TABLE 2

| Discovered | Sending | Sending | Exploratory |
|---|---|---|---|
| (receiving) | Module | Module | (sending) |
| interface | S/N | type | interface |
| B2 | 1104 | B0 | B10 |
| B3 | 1103 | C0 | C3 |
| B4 | 1103 | C0 | C2 |
| B5 | 1103 | C0 | C1 |
| B6 | 1101 | A0 | A3 |
| B7 | 1101 | A0 | A2 |

Note that if each controller 120₀₀-120₀₄ sends exploratory packets over its detection interfaces, each pair of facing transceivers appears twice in the connectivity tables: once in connectivity table of each of the neighboring modules. This adds a level of redundancy that can improve cross-checking and correction algorithms when verifying the tessellation configuration.

In some embodiments, the receiving module reports to connectivity table from one sending detection interface from each unique sending module, as main module 120₀₀ can determine the extents of an identified sending module relative to the position of a receiving detection interface and identified sending detection interface, given the sending module type. For example, module B0 S/N 1102 may record connectivity only for receiving detection interfaces B2 connected to module 1104 detected at B10, B3 connected to module 1103 detected at C3, and B6 connected to module 1101 detected at A3. Alternatively, the receiving module reports to connectivity table from all sending interfaces, providing a redundancy useful for checking and error correction.

Connectivity tables from discovered module controllers 120₀₁-120₀₄ is sufficient information for main controller 120₀₀ to complete self-configuration 800. However, in some embodiments each sending module waits for a receiving module to acknowledge the exploratory packet from each interface. The receiving module acknowledges with a discovery data packet over the receiving interface transceiver. The discovery packet comprises the receiving module unique identifier (i.e. S/N) and module type, as well as the detection interface identifier of the discovered detected interface. The exploratory module controller receives the discovery packet, and records it along with the exploratory detection interface identifier in a connectivity mirror table. Connectivity mirror table can provide redundancy and a possibility of error checking and correction, if main controller 120₀₀ will find that the amalgamation of connectivity tables is inconsistent with the amalgamation of connectivity mirror tables. Interfaces in questions can be commanded to recheck and re-report their facing interface and module identifiers.

In some alternative embodiments, the exploratory module controller only records from one discovered detected interface from each unique module. For example, each module controller may record an entry in its connectivity mirror table only for the detected interfaces shown with cross-hatched backgrounds in FIG. 7.

In some embodiments, the exploratory module, after discovering a new adjacent module at one detection interface, determines which other detection interfaces of the exploratory module are connected to the same discovered module (based on the discovered detection interface identifier, and orientation of the discovered module determined therefrom), and the exploratory module then refrains from sending a discovery packet through its detection interfaces so determined. For example, each module controller may send an exploratory packet only to the detected interfaces shown with cross-hatched backgrounds in FIG. 7.

Self-configuration 800 further comprises transmitting of connectivity tables and associated module identifiers over the network 840, by module controllers 120₀₁-120₀₄ to main controller 120₀₀. The transmissions can be coordinated and made using protocols and/or algorithms known in the art.

In some embodiments, connectivity tables and/or connectivity mirror tables are sent by a reporting module to main controller 120₀₀ in real time, enabling reporting modules to check with main module 120₀₀ in real time as to whether a module discovering or discovered by the reporting model has already been reported by another module. This can enable the reporting module to skip transmissions via detection interfaces connected to the already reported module.

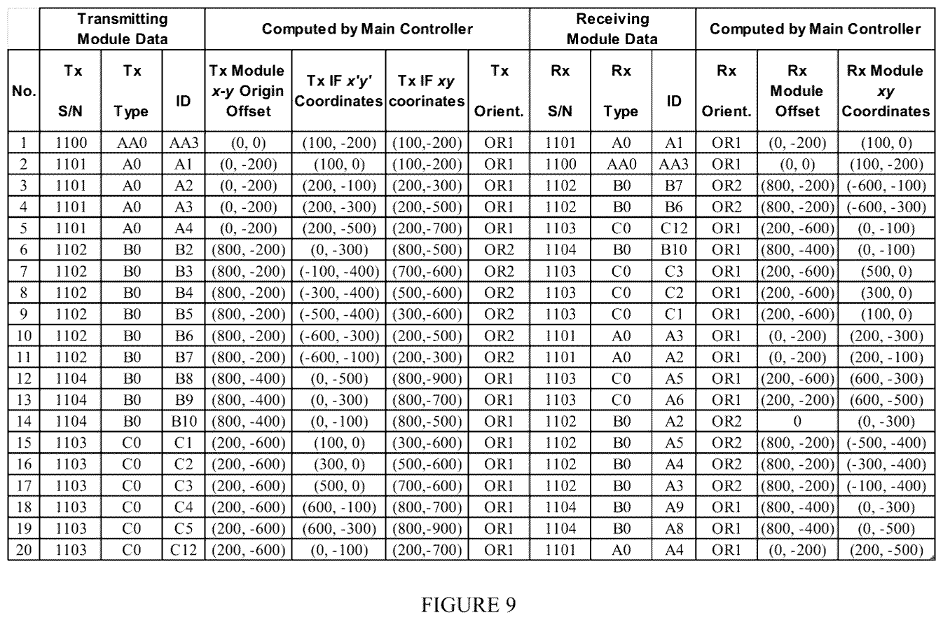

Self-configuration 800 further comprises main module 120₀₀ constructing a tessellation table 845. The tessellation table comprises orientations of the modules, absolute coordinates of facing detection interfaces, and extents of the tabletop and tessellation of the modules. Constructing 845 is made based on the aggregation of the connectivity tables received from module controllers 120₀₁-120₀₄. Such a table is shown in FIG. 9.

For example, starting with main module 1100 positioned at default orientation OR1 (see row 1 in FIG. 9), at transmitting (exploratory) interface AA3 main controller 120₀₀ finds receiving (discovered) interface A1 of neighboring module 1101. In the embodiment shown, main module 1100 defines the X-Y absolute coordinate system—that is, the module axes x′-y′ of module 1100 are the absolute X-Y axes of the entire apparatus 700. Main controller 120₀₀ recognizes module 1101 as being in the OR1 orientation (see FIG. 6B), based on the known OR1 orientation of module AA0 (by definition), and that AA3 detects interface A1 of module type A0 of module 1101. Main controller 120₀₀ records the offset of transmitting interface AA3 from the origin of main module 1100, at absolute coordinates (0, 0). The AA3 connection interface coordinates are (100, −200). The absolute coordinates of AA3 are (100, −200). The interface facing AA3, A1 of module 1101, has the same absolute coordinates, (100, −200) as AA3. Main controller 120₀₀, knowing that module 1100 is of type AA0 and module 1101 is of type A0, computes the absolute coordinates of the module axis origin (of x′-y′ module axis) of module 1101, (0, −200).

Main controller 120₀₀ continues constructing the tessellation table 845 from module 1101 (see row 3 in FIG. 9). Transmitting (exploratory) interface A2 of module 1101 is facing interface B7 of neighboring module 1102. The module (relative) coordinates of the A2 interface is known, by convention, to be (200, −100). From the row 1 record, the absolute coordinates of the module 1101 origin is known to be (0, −200). The absolute X-Y coordinates of the A2 and B7 interface is the sum of these two coordinates, (200, −300), given the OR1 orientation of module 1101. Main module controller 120₀₀ calculates the orientation of neighboring module B0, S/N 1102, as OR2 based on the module 1101 orientation OR1 and the detection interface A2-B7 pairing of the neighboring modules 1101 and 1102. Furthermore, main controller 120₀₀ calculates the absolute coordinates of the module 1102 origin (at the corner of B1 and B10) as (800, −200), given module 1102 coordinates, (100, −600), of the B7 interface. The absolute coordinates of A2 and B7 are (200, −300), which can be calculated by adding the module coordinates of B7 (in the module 1102 B0-type module coordinate system), (-600,-100), offset by the absolute X-Y coordinates (800, −200) of module 1102 origin.

Main controller 120₀₀ continues the calculation until all modules that reported connectivity tables are accounted for. In some embodiments, main controller continues cross-checking of redundant data, further described herein. From the tessellation table in FIG. 9, main controller may map the corners of all modules, now that the X-Y tabletop coordinates of their module origins and their orientations are known, and their physical extents are known from the module type AA0-C0 of each module.

It is appreciated that the self-configuration method 800 disclosed herein is non-limiting. A person skilled in the art, given the teachings of the invention disclosed in this application, may implement a self-configuration result using a method whose details differ from the disclosed configuration method example.

Note: A substantially similar non-limiting explanation of a self-configuration method is found in Appendices A-C.

### Various Embodiments

Reference is now made to FIG. 10A, showing a tabletop apparatus 1000A, according to some embodiments of the invention.

Apparatus modules 104 comprise a door-sliding module 170, shelf lifting module 175, QA post module 180, a tray magazine module 155 for feeding tray modules to lift module (further described herein), and a main plate module 105M.

A cobot 15 is mounted on a cobot adapter plate 185 placed on main plate module 105M and positioning in known relation to the Positioning arrangements. Cobot adapter plate 185 comprises feed-through connectors for power and data connections and pneumatic controls required for operation of cobot 15, thereby simplifying substitution or replacement of cobot 15. A controller of cobot 15 may be a part of the main controller 120M of apparatus 1000A, or may be a separate controller in communicative connection with main controller 120M.

An inlay tray 140 is positioned on a plate module 105 of tabletop 1000A with positioning arrangements (further described herein) of plate module 105. Given a type ID from a standard set of inlay trays—either manually by a UI of controlling software or by some encoding of inlay tray 140 transmitted to plate module 105 and then over the wireless network to main controller 120M—inlays of tray 140 are disposed in known positions relative to positioning arrangements 110 in periodic and known positioning locations. Raw workpieces may be wedged into corners of inlays, thereby being in a predictive position that cobot 15 may be programmed to lift raw workpieces (of known size) from. Such predictive positioning also applies to heights of shelves in shelving module 155.

Cobot 15 is programmed to periodically place finished or partially processed workpieces (e.g., every 1,000 finished workpieces) on placement pads (in this example, nos. 1-5) of QA post module 180, typically used for quality assurance checks. A beam of a photo-interrupter 182 of QA post module 180 passes over the top surface of the placement pads 1-5. Photo-interrupter 182 permits notification—e.g., indicator light; notifications may be communicated over the dedicated wireless network of apparatus 1000A, further described herein—to personnel that QA post module 180 is populated by one or more finished workpieces. Upon processing of 5,000 pieces (in our example), indicating that all five placement pads are filled, the cobot program initiates an alert that the five QA pieces are completed. Cobot program may continue processing by the cobot, but if photo-interrupter 182 is still blocked after processing of 1,000 more pieces, the cobot program pauses the processing because no slot is available for placing the next QA sample. There may be another, more attention-grabbing alert until the five QA samples are taken and the photo-interrupter path is cleared. When it is cleared, cobot program resumes processing from the point it stopped.

Reference is now made to FIGS. 10B and 10C. FIG. 10B shows door-sliding module 170 viewed from the side of a machine (not shown). A hook interface 171 is connected to a hook protruding from a sliding door of the machine. A motor 173 of door sliding module 170 slides hook interface 171 so the machine door opens and closes. FIG. 10C shows door-sliding module 170 viewed from the side of the rest of apparatus 1000A. Mounting hangers 172 attaches door-sliding module 170 to a frame of apparatus 1000A. Alternatively, or additionally, door-sliding module 170 is attached to apparatus by standard screws and/or by customized connection elements, or, alternatively or in addition, by one or more connection arrangements 112, further described herein. A controller of door-sliding module 170 may be interfaced with apparatus 1000A by direct dedicated connection to module controller or by one or more interface modules 107 of door-sliding module 170, further described herein. Main module 120M may send opening and closing instructions to door-sliding module 170 over the wireless network, or alternatively module controller that might be directly connected to the door-sliding module 170 may send opening and closing instructions to door-sliding module 170, before and after cobot 15 places a workpiece in the machine and removes a processed workpiece from the machine.

Reference is now made to FIG. 10D, showing a combined tray magazine module 155 and lift module 158. Tray magazine module 155 comprises a number of trays 156 (which can be inlay trays 140; see FIG. 1) on slides 157, disposed at different levels. Lift module 158 comprises an elevator platform 159 and an appropriate hoisting mechanism, which can be pneumatically or electrically powered. Lift module 158 can be programmed for elevator platform 159 to move to a position and receive or unload a tray 156 at this position. Lift module 158 and/or tray magazine module 155 have an appropriate sliding mechanism for transferring trays 156 between slides 157 and elevator platform 159.

Lift module 158 can elevate a tray 156 to the tabletop surface level. On the surface there can be slides 157 for transferring a tray between the top surfaces of tray magazine module 155 and a plate module 105 atop tray magazine module 155. The tabletop surface may thus be enabled to hold two trays 156. The combined tray magazine 155 and lift module 158 enables, for example, manually loading unfinished workpieces on trays 156 on multiple levels, for subsequent manipulation and processing of workpieces from the top surface, thereby enabling a longer time between manual reloading. Additionally (or alternatively), for example, after being processed workpieces can be robotically placed on a tray 156 at the top surface and the tray 156 can subsequently be carried to a a lower level of tray magazine module 155.

Lift module 158 and tray magazine module 155 may be joined to each other and/or to other modules of the apparatus by connection arrangements 112 and/or detection interfaces 107, in accordance with teachings disclosed herein.

Reference is now made to FIG. 10E, showing a tessellation 160 of hexagonal plates and a tessellation 165 of octagonal plates.

Note, in FIG. 10F, that for the hexagonal tessellation 160, connection locations are periodic in the x₁, x₂, and x₃ dimensions. In all three dimensions, the period is equal to the extent (between parallel edges) of the hexagonal plates.

For the octagonal tessellation 165, connection locations are periodic with periods, in the x₁ and y₁ dimensions, equal to the extent of the octagonal plates. In the x₂ and y₂ dimensions, pairs of connection locations are periodic with periods equal to the extent of the octagonal plates. Each pair of connection arrangements are between an interstitial square plate and adjacent octagonal plates.

Reference is now made to FIG. 10G, showing an apparatus 1000G with a hub-and-spoke tessellation, comprising a central octagonal plate module 105_{OCT}. Connected to the edges of octagonal plate module 105_{OCT} are two conveyor modules 190 and three spoke-like rectangular modules 105_{RECT}. Conveyor modules 190 are connected to octagonal module 105_{OCT} by connection arrangements 112. Controllers of conveyor modules 190 may be interfaced with apparatus 1000F by one or more interface modules 107 of each conveyor modules 190. Conveyor modules 190 may thereby be identified by main controller 120M—the surface area of its conveyor belt is specially identified as such—and be authorized to connect to the wireless network and its motion may controlled over the wireless network by main controller 120M or by a module controller. The apparatus 1000F of FIG. 10F is especially useful for conveying workpieces between two separate workstations, and the rectangular modules 105_{RECT} provide additional stations, for example, for personnel to attend to manual processes or for expanding the Tabletop apparatus as required in a modular and flexible way.

Note that octagonal plate module 105_{OCT} and each of the other rectangular modules each have their own coordinate dimensions with regard to positioning, connection, and interface periodicities. The self-configuration method (described further herein) of tabletop 1000G further includes a step of transforming between the coordinate systems of neighboring rectangular module and octagonal modules, in order to seamlessly enable calculation of tessellation of the entire tabletop 1000G and motion of a robot to correct positions on both the rectangular and octagonal modules.

Reference is now made to FIG. 10H, showing a tabletop apparatus 1000H with one or more vertically oriented modules 170 (or vertical portions of horizontal modules). A special connection insert 175A is used for connecting a vertically oriented module between two horizontal modules. In an alternative embodiment (not shown), vertical plate 170 can be held by one or more positioning inserts, which may be insertable into positioning arrangements of a horizontal plate module, thereby enabling placement of vertical module 170 at positions within the positioning grid of a plate module (not only between modules).

Apparatus 1000H may further comprise connection insert 175B for connecting two vertical modules meeting at a right angle. However, connection insert 175B can be designed to allow vertical modules 170 to intersect at any desired angle.

Vertical plates 170 may be their own module with their own detection interfaces, adapted for right-angle connection with detection interfaces of horizontal modules. Alternatively, a vertical plate 170 can be part of a horizontal module.

In addition could additional horizontal modules be positioned horizontally connected to the vertical module creating a box or shelf type module arrangement, as shown in FIG. 10I.

Horizontal modules may be mounted to vertical plates, as shown in FIG. 10I, thereby forming an arrangement of one or more box-like compartments and/or shelf levels.

1. A modular, self-configuring tabletop apparatus comprising
a. two or more modules configured to form a tessellation when placed in a side-by-side arrangement; each said module comprising:
(i) edges oriented in one or more dimensions;
(ii) one or more detection interfaces disposed along said edges at interface locations and configured to form facing pairs with detection interfaces of an adjacent module; and
(iii) the interface locations periodically spaced by a location period of each of the one or more dimensions, wherein a tessellation extent of each said edge in each said dimension is an integer multiple of the location periods of said dimension; and
b. a main controller configured to:
receive at least one of the following indications:
(i) the position of a first detection interface on a first module in relation to a second detection interface on a second module;
(ii) the position of said second detection interface on said second module; and
(iii) the tessellation extents of said first module and of said second module in said one or more dimensions; and
compute, as a function of said indications, at least one of
(i) an overall size of said tessellation;
(ii) an overall shape of said tessellation; or
(iii) an orientation between two or more of said modules.

2. The apparatus of claim 1, wherein one or more of said interface locations is unpopulated by a said detection interface.

3. The apparatus of claim 1, wherein one or more of said detection interfaces are disposed on a structural support supporting said module.

4. The apparatus of claim 1, wherein said module shapes are at least one of rectangles, triangles, quadrilaterals, hexagons, octagons, or any combination thereof.

5. The apparatus of claim 1, wherein said modules are rectangular and said interface locations are periodic in an x-dimension at an location period Pᵢₓ and in a y-dimension at an location period P_{iy}, said main controller further configured to compute a shape of said tabletop.

6. The apparatus of claim 5, wherein each said module further comprises:
one or more connection arrangements configured for attaching said adjacent modules;
the connection arrangements are disposed along the edges and occupy locations periodically spaced in said one or more dimensions by a connection period of each said one or more dimensions, wherein
pairs of said connection arrangements meet along adjacent edges of said adjacent modules, and
a tessellation extent of each said module along each said edge that comprises said periodically spaced connection locations is an integer multiple of said connection period of said dimension.

7. The apparatus of claim 6, wherein said connection locations are periodic in said x-dimension at a connection period P_{cx} and in said y-dimension at a connection period P_{cy}.

8. The apparatus of claim 7, wherein said location period in the x-dimension and said connection period in the x-dimension are equal (Pᵢₓ=P_{cx}=P_{icx}); and said location period in the y-dimension and said connection period in the y-dimension are equal (P_{iy}=P_{cy}=P_{icy}).

9. The apparatus of claim 8, wherein said connection x and y periods are equal (P_{icx}=P_{icy}=P_{ic}).

10. The apparatus of claim 9, wherein said modules comprise one or more plates, each said plate comprising positioning arrangements thereon, said positioning arrangements disposed on a surface of said plate at positioning locations periodically spaced in at least one dimension of said surface at a positioning period of each of said at least one dimension; tessellation extents of each said module in each said at least one dimension is an integer multiple of said positioning period.

11. The apparatus of claim 10, wherein said positioning locations have a said positioning period along said x-dimension at a positioning period Pₚₓ and along said y-dimension at a positioning period P_{py}.

12. The apparatus of claim 11, wherein said connection location period is at least one of:
an integer multiple of said positioning period in the x-dimension (P_{ic}=mPₚₓ); and
said connection location period is an integer multiple of said positioning period in the y-dimension (P_{ic}=nP_{py}), and;
are equal to said x and y positioning periods (P_{ic}=Pₚₓ=P_{py}; m=n=1).

13. The apparatus of claim 5, wherein said modules comprise one or more plates, each said plate comprising one or more positioning arrangements thereon, said positioning arrangements disposed on a surface of said tabletop at positioning locations periodically spaced in at least one dimension of said surface at a positioning period of each of said at least one dimension; tessellation extents of each said module in each said at least one dimension is an integer multiple of said positioning period.

14. The apparatus of claim 13, wherein said positioning locations have a said positioning period along said x-dimension at a positioning period Pₚₓ and along said y-dimension at a positioning period P_{py}.

15. The apparatus of claim 14, wherein said location period in the x-dimension is an integer multiple of said positioning period in the x-dimension (Pᵢₓ=mPₚₓ); and said location period in the y-dimension is an integer multiple of said positioning period in the y-dimension (P_{iy}=nP_{py}).

16. The apparatus of claim 15, wherein said x and y location periods are equal and said x and y positioning periods are equal mPₚₓ=nP_{py}=Pₚ.

17. The apparatus of claim 1, each said module further comprises a module controller, wherein the transceivers, the module controller, and the main controller are configured to communicate with each other through communicative connections.

18. The apparatus of claim 17, wherein said one or more detection interfaces comprise a micro-switch, an RFID card, a proximity sensor, an optical sensor, RF transceivers, magnetic sensors, or any combination thereof.

19. The apparatus of claim 17, wherein said communicative connections are through at least one of: a wired network; a wireless network; or any combination thereof.

20. A method for self-configuring of a tabletop apparatus, comprising:
positioning modules of the tabletop apparatus in a side a side-by-side arrangement to form a tessellation of modules, wherein each said module comprises:
(i) edges oriented in one or more dimensions;
(ii) one or more detection interfaces disposed along said edges at interface locations; and
(iii) the interface locations periodically spaced by a location period of each of the one or more dimension;
aligning said detection interfaces to form facing pairs with detection interfaces of an adjacent module, wherein a tessellation extent of each said edge in each said dimension is an integer multiple of the interface-location period of said dimension;
receiving at least one of the following indications:
(i) the position of a first detection interface on a first module in relation to a second detection interface on a second module;
(ii) the position of said second detection interface on said second module; and
(iii) the tessellation extents of said first module and of said second module in said one or more dimensions; and
computing, by the main controller, as a function of said indications, at least one of
(i) an overall size of said tessellation;
(ii) an overall shape of said tessellation; or
(iii) an orientation between two or more of said modules.
